(19) United States
(12) Patent Application Publication
(10) Pub. No.: US 2025/0310792 A1
(43) Pub. Date: Oct. 2, 2025

(54) Network Optimization based on Distributed Multi-agent Machine Learning With Minimal Inter-Agent Dependency

(71) Applicant: Nokia Solutions and Networks Oy, Espoo (FI)

(72) Inventors: Qi LIAO, Stuttgart (DE); Senthil Kumaran K, Bangalore (IN); Dan WELLINGTON, Boulder, CO (US); Ahmad AWADA, Munich (DE)

(21) Appl. No.: 18/866,900

(22) PCT Filed: May 19, 2022
(86) PCT No.: PCT/EP2022/063572

§ 371 Date: Nov. 18, 2024

(51) Int. Cl. H04W 24/02; H04L 41/16; H04W 84/18

(52) U.S. Cl. CPC H04W 24/02; H04L 41/16; H04W 84/18

(57) ABSTRACT

Network optimization based on distributed multi-agent machine learning with minimal inter-agent dependency is disclosed. At least some of the embodiments may allow a distributed multi-agent deep reinforcement learning (DRL) algorithm for a mobility robustness optimization (MRO) problem, where each agent may comprise a varying number of physical or logical network boundaries. At least some of the embodiments may allow minimizing inter-agent dependencies by decomposing a network mobility graph. At least some of the embodiments may allow a transfer learning framework for self-organizing network (SON) model profiling, storage, retrieval, retraining, and management such that one can efficiently retrieve a SON model that was pre-trained in a similar (sub) network environment.

### TECHNICAL FIELD

The disclosure relates generally to communications and, more particularly but not exclusively, to network optimization based on distributed multi-agent machine learning with minimal inter-agent dependency.

### BACKGROUND

While fifth generation (5G) mobile networks have been emphasizing network virtualization, it is expected that sixth generation (6G) networks will focus on autonomous intelligence of highly complex network systems consisting of both physical and logical network entities. For example, the introduction of network slicing into self-organizing network (SON) functionalities may lead to more complex optimization problems in the following three aspects: 1) it may increase the dimensions of network states by introducing slice-specific key performance indicators (KPIs), 2) it may increase the dimensions of optimization variables due to the slice-specific network configuration parameters, and 3) it may make the modeling of utility functions more difficult due to highly nonlinear inter-dependencies between high-dimensional parameters.

Currently, when using machine learning to solve network optimization problems, there is tradeoff between a centralized (single agent) scheme and a distributed (multi-agent) scheme: although training a single agent in the centralized scheme can capture inter-cell dependencies, it may require an extremely long period of exploration and cause slow convergence, if it converges at all, due to an intractably high-dimensional action space. On the other hand, the distributed scheme decomposes a system consisting of many network entities into subsystems, e.g., optimizing on the cell or cell pair basis, which reduces the complexity and accelerates the learning process, but the neglecting of inter-agent dependency may lead to poor performance due to inaccurate modeling based on limited information. Neglecting the inter-agent dependency may also lead to longer convergence times.

Thus, at least in some situations, there may be a need for network optimization based on distributed multi-agent machine learning with minimal inter-agent dependency. Moreover, training many distributed agents faces challenges, such as cost of data collection and storage, learning time, algorithm scalability, and artificial intelligence (AI)/machine learning (ML) model reproducibility. Thus, at least in some situations, there may be a need for an automatic workflow that can detect a similarity between the agents and reuse the knowledge and models in order to avoid having to learn from scratch for a large amount of the distributed agents.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of a communications network device comprises at least one processor, and at least one memory including computer program code. The at least one memory and the computer program code are configured to, with the at least one processor, cause the communications network device at least to decompose a communications network into service level agreement, SLA, coverage overlap regions, SCORs, according to mobility relations between logical network entity, LNE, pairs within the communication network. The SCOR comprises at least one LNE pair. The at least one memory and the computer program code are further configured to, at least one processor, cause the with the communications network device at least to assign a machine learning agent to at least one of the decomposed SCORs. The machine learning agent is configured to apply a deep reinforcement learning model to solve an optimization problem related to a self-organizing network, SON, function within its assigned SCOR.

In an example embodiment, alternatively or in addition to the above-described example embodiments, LNE pairs in a SCOR comprising at least two LNE pairs are strongly coupled, and dependency between the SCORs is low.

In an example embodiment, alternatively or in addition to the above-described example embodiments, the at least one memory and the computer program code are further configured to, with the at least one processor, cause the communications network device to decompose the communications network into the SCORs by generating a logical network graph corresponding to the communications network and representing the mobility relations between the LNE pairs, and by decomposing the logical network graph into subgraphs. The subgraphs represent SCORs comprising strongly coupled LNE pairs.

In an example embodiment, alternatively or in addition to the above-described example embodiments, vertices of the logical network graph comprise the LNE pairs, and weights of edges of the logical network graph reflect a mobility relationship between two LNE pairs.

In an example embodiment, alternatively or in addition to the above-described example embodiments, the at least one memory and the computer program code are further configured to, with the at least one processor, cause the communications network device at least to generate a profile for the subgraph. The profile comprises an adjacency matrix or an adjacency list representing the respective subgraph.

In an example embodiment, alternatively or in addition to the above-described example embodiments, the profile further comprises at least one of: a number of vertices, a number of edges, a number of involved LNEs, a degree distribution, a distribution of edge weights, a distribution of summed weights of edges incident to a vertex, or at least one LNE specific feature for the respective subgraph including at least one of a deployment type, an LNE type, an associated user mobility distribution, position information, or an LNE load state.

In an example embodiment, alternatively or in addition to the above-described example embodiments, the at least one memory and the computer program code are further configured to, with the at least one processor, cause the communications network device at least to obtain the deep reinforcement learning model as pre-trained from a SON node device.

In an example embodiment, alternatively or in addition to the above-described example embodiments, states of the assigned machine learning agent comprise at least one of: LNE-specific metrics, LNE pair-specific metrics, or contextual information for capturing at least one of temporal or spatial correlations.

In an example embodiment, alternatively or in addition to the above-described example embodiments, an action space of the assigned machine learning agent comprises a discrete action space or a continuous action space.

In an example embodiment, alternatively or in addition to the above-described example embodiments, rewards for the assigned machine learning agent are based on at least one of: LNE pair-specific handover performance metrics, LNE-specific quality of service, Qos, performance metrics, or LNE pair-specific QoS performance metrics.

In an example embodiment, alternatively or in addition to the above-described example embodiments, the SON function comprises a mobility robustness optimization, MRO, function, a coverage and capacity optimization function, or a mobility load balancing function.

In an example embodiment, alternatively or in addition to the above-described example embodiments, the MRO function comprises optimization of one or more handover parameters.

In an example embodiment, alternatively or in addition to the above-described example embodiments, the SCOR further comprises group of physical cell boundaries, a group of logical cell boundaries, or a group of physical cell boundaries and logical cell boundaries.

In an example embodiment, alternatively or in addition to the above-described example embodiments, the LNEs comprise at least one of cells, slices, or Qos flows.

In an example embodiment, alternatively or in addition to the above-described example embodiments, the generating network graph comprises generating the logical network graph based on historical LNE data, statistical mobility data, or an SLA coverage map.

An example embodiment of a communications network device comprises means for decomposing communications network into service level agreement, SLA, coverage overlap regions, SCORs, according to mobility relations between logical network entity, LNE, pairs within the communication network. The SCOR comprises at least one LNE pair. The means are further configured to assign a machine learning agent to at least one of the decomposed SCORs. The machine learning agent is configured to apply a deep reinforcement learning model to solve an optimization problem related to a self-organizing network, SON, function within its assigned SCOR.

In an example embodiment, alternatively or in addition to the above-described example embodiments, LNE pairs in a SCOR comprising at least two LNE pairs are strongly coupled, and dependency between the SCORs is low.

In an example embodiment, alternatively or in addition to the above-described example embodiments, the means are further configured to decompose the communications network into the SCORs by generating a logical network graph corresponding to the communications network and representing the mobility relations between the LNE pairs, and by decomposing the logical network graph into subgraphs. The subgraphs represent SCORs comprising strongly coupled LNE pairs.

In an example embodiment, alternatively or in addition to the above-described example embodiments, vertices of the logical network graph comprise the LNE pairs, and weights of edges of the logical network graph reflect a mobility relationship between two LNE pairs.

In an example embodiment, alternatively or in addition to the above-described example embodiments, the means are further configured to generate a profile for the subgraph. The profile comprises an adjacency matrix or an adjacency list representing the respective subgraph.

In an example embodiment, alternatively or in addition to the above-described example embodiments, the profile further comprises at least one of: a number of vertices, a number of edges, a number of involved LNEs, a degree distribution, a distribution of edge weights, a distribution of summed weights of edges incident to a vertex, or at least one LNE specific feature for the respective subgraph including at least one of a deployment type, an LNE type, an associated user mobility distribution, position information, or an LNE load state.

In an example embodiment, alternatively or in addition to the above-described example embodiments, the means are further configured to obtain the deep reinforcement learning model as pretrained from a SON node device.

In an example embodiment, alternatively or in addition to the above-described example embodiments, states of the assigned machine learning agent comprise at least one of: LNE-specific metrics, LNE pair-specific metrics, or contextual information for capturing at least one of temporal or spatial correlations.

In an example embodiment, alternatively or in addition to the above-described example embodiments, an action space of the assigned machine learning agent comprises a discrete action space or a continuous action space.

In an example embodiment, alternatively or in addition to the above-described example embodiments, rewards for the assigned machine learning agent are based on at least one of: LNE pair-specific handover performance metrics, LNE-specific quality of service, Qos, performance metrics, or LNE pair-specific QoS performance metrics.

In an example embodiment, alternatively or in addition to the above-described example embodiments, the SON function comprises a mobility robustness optimization, MRO, function, a coverage and capacity optimization function, or a mobility load balancing function.

In an example embodiment, alternatively or in addition to the above-described example embodiments, the MRO function comprises optimization of one or more handover parameters.

In an example embodiment, alternatively or in addition to the above-described example embodiments, the SCOR further comprises a group of physical cell boundaries, a group of logical cell boundaries, or a group of physical cell boundaries and logical cell boundaries.

In an example embodiment, alternatively or in addition to the above-described example embodiments, the LNEs comprise at least one of cells, slices, or Qos flows.

In an example embodiment, alternatively or in addition to the above-described example embodiments, the generating of the logical network graph comprises generating the logical network graph based on historical LNE data, statistical mobility data, or an SLA coverage map.

An example embodiment of a method comprises decomposing, by a communications network device, a communications network into service level agreement, SLA, coverage overlap regions, SCORs, according to mobility relations between logical network entity, LNE, pairs within the communication network. The SCOR comprises at least one LNE pair. The method further comprises assigning, by the communications network device, a machine learning agent to at least one of the decomposed SCORs. The machine learning agent is configured to apply a deep reinforcement learning model to solve an optimization problem related to a self-organizing network, SON, function within its assigned SCOR.

In an example embodiment, alternatively or in addition to the above-described example embodiments, LNE pairs in a SCOR comprising at least two LNE pairs are strongly coupled, and dependency between the SCORs is low.

In an example embodiment, alternatively or in addition to the above-described example embodiments, the method further comprises decomposing the communications network into the SCORs by generating a logical network graph corresponding to the communications network and representing the mobility relations between the LNE pairs, and by decomposing the logical network graph into subgraphs. The subgraphs represent SCORs comprising strongly coupled LNE pairs.

In an example embodiment, alternatively or in addition to the above-described example embodiments, vertices of the logical network graph comprise the LNE pairs, and weights of edges of the logical network graph reflect a mobility relationship between two LNE pairs.

In an example embodiment, alternatively or in addition to the above-described example embodiments, the method further comprises generating a profile for the subgraph. The profile comprises an adjacency matrix or an adjacency list representing the respective subgraph.

In an example embodiment, alternatively or in addition to the above-described example embodiments, the profile further comprises at least one of: a number of vertices, a number of edges, a number of involved LNEs, a degree distribution, a distribution of edge weights, a distribution of summed weights of edges incident to a vertex, or at least one LNE specific feature for the respective subgraph including at least one of a deployment type, an LNE type, an associated user mobility distribution, position information, or an LNE load state.

In an example embodiment, alternatively or in addition to the above-described example embodiments, the method further comprises obtaining the deep reinforcement learning model as pretrained from a SON node device.

In an example embodiment, alternatively or in addition to the above-described example embodiments, states of the assigned machine learning agent comprise at least one of: LNE-specific metrics, LNE pair-specific metrics, or contextual information for capturing at least one of temporal or spatial correlations.

In an example embodiment, alternatively or in addition to the above-described example embodiments, an action space of the assigned machine learning agent comprises a discrete action space or a continuous action space.

In an example embodiment, alternatively or in addition to the above-described example embodiments, rewards for the assigned machine learning agent are based on at least one of: LNE pair-specific handover performance metrics, LNE-specific quality of service, Qos, performance metrics, or LNE pair-specific Qos performance metrics.

In an example embodiment, alternatively or in addition to the above-described example embodiments, the SON function comprises a mobility robustness optimization, MRO, function, a coverage and capacity optimization function, or a mobility load balancing function.

In an example embodiment, alternatively or in addition to the above-described example embodiments, the MRO function comprises optimization of one or more handover parameters.

In an example embodiment, alternatively or in addition to the above-described example embodiments, the SCOR further comprises a group of physical cell boundaries, a group of logical cell boundaries, or a group of physical cell boundaries and logical cell boundaries.

In an example embodiment, alternatively or in addition to the above-described example embodiments, the LNEs comprise at least one of cells, slices, or Qos flows.

In an example embodiment, alternatively or in addition to the above-described example embodiments, the generating of the logical network graph comprises generating the logical network graph based on historical LNE data, statistical mobility data, or an SLA coverage map.

An example embodiment of a computer program comprises instructions for causing a communications network device to perform at least the following: decomposing a communications network into service level agreement, SLA, coverage overlap regions, SCORS, according to mobility relations between logical network entity, LNE, pairs within the communication network, the SCOR comprising at least one LNE pair; and assigning a machine learning agent to at least one of the decomposed SCORs. The machine learning agent is configured to apply a deep reinforcement learning model to solve an optimization problem related to a self-organizing network, SON, function within its assigned SCOR.

An example embodiment of a self-organizing network, SON, node device comprises at least one processor, and at least one memory including computer program code. The at least one memory and the computer program code are configured to, with the at least one processor, cause the SON node device at least to receive from a communications network device a request for a pretrained deep reinforcement learning model for use in solving an optimization problem related to a self-organizing network, SON, function within a service level agreement, SLA, coverage overlap region, SCOR. The request comprises at least one profile of at least one subgraph of a logical network graph representing mobility relations between logical network entity, LNE, pairs. The SCOR comprises at least one LNE pair and the at least one subgraph corresponds to the SCOR. The at least one memory and the computer program code are further configured to, with the at least one processor, cause the SON node device at least to determine a pretrained reference deep reinforcement learning model from a model database by a similarity analysis based on the profile of the subgraph. The at least one memory and the computer program code are further configured to, with the at least one processor, cause the SON node device at least to transmit the determined pre-trained reference deep reinforcement learning model to the communications network device.

In an example embodiment, alternatively or in addition to the above-described example embodiments, the similarity analysis comprises a relational similarity analysis between the at least one subgraph in the received at least one profile and subgraphs associated with the pretrained reference deep reinforcement learning models stored in the model database.

In an example embodiment, alternatively or in addition to the above-described example embodiments, the at least one memory and the computer program code are configured to, with the at least one processor, further cause the SON node device to customize the determined reference deep reinforcement learning model and transmit the customized deep reinforcement learning model to the communications network device.

In an example embodiment, alternatively or in addition to the above-described example embodiments, the at least one memory and the computer program code are configured to, with the at least one processor, further cause the SON node device to prescreen the profile of the subgraph based on one or more pre-screening parameters to determine one or more candidate pre-trained reference deep reinforcement learning models. The determining of the pretrained reference deep reinforcement learning model is performed on the determined one or more candidate pretrained reference deep reinforcement learning models.

An example embodiment of a self-organizing network, SON, node device comprises means for receiving from a communications network device a request for a pretrained deep reinforcement learning model for use in solving an optimization problem related to a self-organizing network, SON, function within a service level agreement, SLA, coverage overlap region, SCOR. The request comprises at least one profile of at least one subgraph of a logical network graph representing mobility relations between logical network entity, LNE, pairs. The SCOR comprises at least one LNE pair, and the at least one subgraph corresponds to the SCOR. The means further configured to determine a pretrained reference deep reinforcement learning model from a model database by a similarity analysis based on the profile of the subgraph. The means are further configured to transmit the determined pretrained reference deep reinforcement learning model to the communications network device.

In an example embodiment, alternatively or in addition to the above-described example embodiments, the similarity analysis comprises a relational similarity analysis between the at least one subgraph in the received at least one profile and subgraphs associated with the pretrained reference deep reinforcement learning models stored in the model database.

In an example embodiment, alternatively or in addition to the above-described example embodiments, the means are further configured to customize the determined reference deep reinforcement learning model and transmit the customized deep reinforcement learning model to the communications network device.

In an example embodiment, alternatively or in addition to the above-described example embodiments, the means are further configured to prescreen the profile of the subgraph based on one or more prescreening parameters to determine one or more candidate pretrained reference deep reinforcement learning models. The determining of the pretrained reference deep reinforcement learning model is performed on the determined one or more candidate pretrained reference deep reinforcement learning models.

An example embodiment of a method comprises receiving at a self-organizing network, SON, node device from a communications network device a request for a pretrained deep reinforcement learning model for use in solving an optimization problem related to a self-organizing network, SON, function within a service level agreement, SLA, coverage overlap region, SCOR. The request comprises at least one profile of at least one subgraph of a logical network graph representing mobility relations between logical network entity, LNE, pairs. The SCOR comprises at least one LNE pair and the at least one subgraph corresponds to the SCOR. The method further comprises determining, by the SON node device, a pretrained reference deep reinforcement learning model from a model database by a similarity analysis based on the profile of the subgraph. The method further comprises transmitting, by the SON node device, the determined pretrained reference deep reinforcement learning model to the communications network device.

In an example embodiment, alternatively or in addition to the above-described example embodiments, the similarity analysis comprises a relational similarity analysis between the at least one subgraph in the received at least one profile and subgraphs associated with the pretrained reference deep reinforcement learning models stored in the model database.

In an example embodiment, alternatively or in addition to the above-described example embodiments, the method further comprises customizing the determined reference deep reinforcement learning model and transmitting the customized deep reinforcement learning model to the communications network device.

In an example embodiment, alternatively or in addition to the above-described example embodiments, the method further comprises prescreening the profile of the subgraph based on one or more prescreening parameters to determine one or more candidate pretrained reference deep reinforcement learning models. The determining of the pretrained reference deep reinforcement learning model is performed on the determined one or more candidate pretrained reference deep reinforcement learning models.

An example embodiment of a computer program comprises instructions for causing a self-organizing network, SON, node device to perform at least the receiving from a communications network following: device a request for a pretrained deep reinforcement learning model for use in solving an optimization problem related to a self-organizing network, SON, function within a service level agreement, SLA, coverage overlap region, SCOR, the request comprising at least one profile of at least one subgraph of a logical network graph representing mobility relations between logical network entity, LNE, pairs, with the SCOR comprising at least one LNE pair and the at least one subgraph corresponding to the SCOR; determining a pretrained reference deep reinforcement learning model from a model database by a similarity analysis based on the profile of the subgraph; and transmitting the determined pretrained reference deep reinforcement learning model to the communications network device.

An example embodiment of a network service provider device comprises at least one processor, and at least one memory including computer program code. The at least one memory and the computer program code are configured to, with the at least one processor, cause the network service provider device at least to obtain from at least one communications network device at least one subgraph of a logical network graph representing mobility relations between logical network entity, LNE, pairs and their associated profiles. The at least one memory and the computer program code are further configured to, with the at least one processor, cause the network service provider device at least to derive at least one pretrained reference deep reinforcement learning model for in solving an optimization problem related to a self-organizing network, SON, function within a service level agreement, SLA, coverage overlap region, SCOR. The SCOR comprises at least one LNE pair and the SCOR corresponds to the subgraph. The at least one memory and the computer program code are further configured to, with the at least one processor, cause the network service provider device at least to store the obtained profiles and the derived pretrained reference deep reinforcement learning models in a model database.

In an example embodiment, alternatively or in addition to the above-described example embodiments, the model database comprises an indexed model database such that a same index represents an obtained profile of one subgraph and a corresponding derived pretrained reference deep reinforcement learning model in a SCOR that corresponds to the subgraph.

An example embodiment of a network service provider device comprises means for obtaining from at least one communications network device at least one subgraph of a logical network graph representing mobility relations between logical network entity, LNE, pairs and their associated profiles. The means are further configured to derive at least one pretrained reference deep reinforcement learning model for use in solving an optimization problem related to a self-organizing network, SON, function within a service level agreement, SLA, coverage overlap region, SCOR. The SCOR comprises at least one LNE pair and the SCOR corresponds to the subgraph. The means are further configured to store the obtained profiles and the derived pretrained reference deep reinforcement learning models in a model database.

In an example embodiment, alternatively or in addition to the above-described example embodiments, the model database comprises an indexed model database such that a same index represents an obtained profile of one subgraph and a corresponding derived pretrained reference deep reinforcement learning model in a SCOR that corresponds to the subgraph.

An example embodiment of a method comprises obtaining, by a network service provider device, from at least one communications network device at least one subgraph of a logical network graph representing mobility relations between logical network entity, LNE, pairs and their associated profiles. The method further comprises deriving, by the network service provider device, at least one pretrained reference deep reinforcement learning model for use in solving an optimization problem related to a self-organizing network, SON, function within a service level agreement, SLA, coverage overlap region, SCOR. The SCOR comprises at least one LNE pair and the SCOR corresponds to the subgraph. The method further comprises storing, by the network service provider device, the obtained profiles and the derived pretrained reference deep reinforcement learning models in a model database.

In an example embodiment, alternatively or in addition to the above-described example embodiments, the model database comprises an indexed model database such that a same index represents an obtained profile of one subgraph and a corresponding derived pretrained reference deep reinforcement learning model in a SCOR that corresponds to the subgraph.

An example embodiment of a computer program comprises instructions for causing a network service provider device to perform at least the following: obtaining from at least one communications network device at least one subgraph of a logical network graph representing mobility relations between logical network entity, LNE, pairs and their associated profiles; deriving at least one pretrained reference deep reinforcement learning model for use in solving an optimization problem related to a self-organizing network, SON, function within a service level agreement, SLA, coverage overlap region, SCOR, with the SCOR comprising at least one LNE pair and the SCOR corresponding to the subgraph; and storing the obtained profiles and the derived pretrained reference deep reinforcement learning models in a model database.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2A shows an example embodiment of the subject matter described herein illustrating a communications network device;

FIG. 2B shows an example embodiment of the subject matter described herein illustrating a SON node device;

FIG. 2C shows an example embodiment of the subject matter described herein illustrating a network service provider device;

FIG. 3A shows an example embodiment of the subject matter described herein illustrating a SCOR and SCOR-based agents;

FIG. 3B shows an example embodiment of the subject matter described herein illustrating deriving of a logical network graph and SCORs from an LNE log history;

FIG. 4 shows an example embodiment of the subject matter described herein illustrating a communications network partitioned to SCORs and their corresponding subgraphs;

FIG. 5 shows an example embodiment of the subject matter described herein illustrating an example representation of a subgraph with an adjacency matrix or an adjacency list;

FIG. 6 shows another example embodiment of the subject matter described herein illustrating an example of subgraph profiling;

FIG. 7 shows an example embodiment of the subject matter described herein illustrating an example of an indexed profile database and an indexed model database;

FIG. 8 shows an example embodiment of the subject matter described herein illustrating an example of an actor network in a deep reinforcement learning architecture;

FIG. 9 shows an example embodiment of the subject matter described herein illustrating an example of direct application of a source model Mₛ (Gₛ) for a target model M_{*} (G_{*});

FIG. 10 shows an example embodiment of the subject matter described herein illustrating an example of knowledge distillation from a source model Mₛ (Gₛ) to a target model M_{*} (G_{*});

FIG. 11 shows an example embodiment of the subject matter described herein illustrating a transfer learning framework with logical network graph-based model retrieval;

FIG. 12 shows an example embodiment of the subject matter described herein illustrating a method;

FIG. 13 shows an example embodiment of the subject matter described herein illustrating another method;

FIG. 14 shows an example embodiment of the subject matter described herein illustrating yet another method;

FIG. 15 shows an example embodiment of the subject matter described herein illustrating deriving an MRG and SCORs from an SLA coverage map;

FIG. 16 shows an example embodiment of the subject matter described herein illustrating MRG decomposition when an LNE is defined as a network slice in a physical cell;

FIG. 17 shows an example embodiment of the subject matter described herein illustrating an example of a deep deterministic policy gradient (DDPG) architecture; and

FIG. 18 shows an example embodiment of the subject matter described herein illustrating an example of a deep Q-network (DON) architecture.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

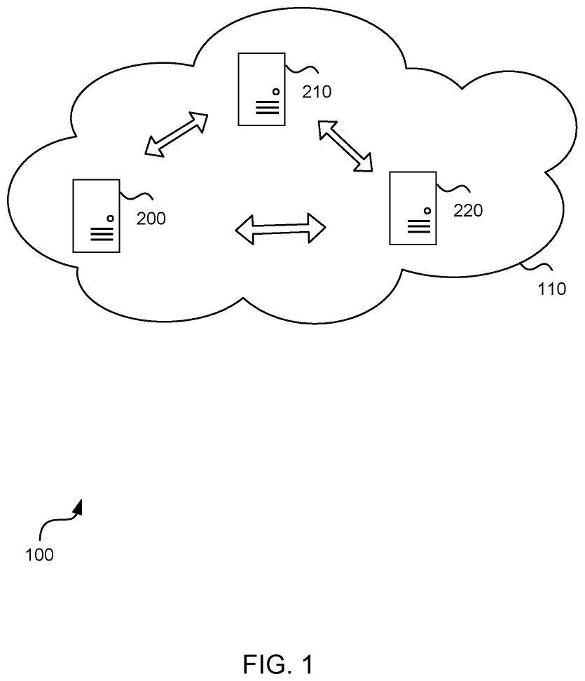

FIG. 1 illustrates an example system 100, where various embodiments of the present disclosure may be implemented. The system 100 may comprise a fifth generation (5G) or a sixth generation (6G) communications network 110. An example representation of the system 100 is shown depicting a communications network device 200, a self-organizing network (SON) node device 210, and a network service provider device 220. At least in some embodiments, the 5G or 6G network may comprise one or more massive machine-to-machine (M2M) network(s), massive machine type communications (mMTC) network(s), internet of things (IoT) network(s), industrial internetof-things (IIoT) network(s), enhanced mobile broadband (eMBB) network(s), ultra-reliable low-latency communication (URLLC) network(s), and/or the like. In other words, the 5G or 6G network may be configured to serve diverse service types and/or use cases, and it may logically be seen as comprising one or more networks.

The communications network device 200 may comprise an operations, administration, and maintenance (OAM) unit, a network node device, or a client device. The client device may include, e.g., a mobile phone, a smartphone, a tablet computer, a smart watch, or any hand-held, portable and/or wearable device. The client device may also be referred to as a user equipment (UE). The network node device may comprise a base station. The base station may include, e.g., a 5G or 6G base station (gNB) or any such device suitable for providing an air interface for client devices to connect to a wireless network via wireless transmissions.

At least some of the disclosed embodiments may be implemented in an O-RAN architecture. The O-RAN aims for interoperability and standardization of RAN elements including a unified interconnection standard for network functions from different vendors. The O-RAN architecture provides a foundation for building a virtualized RAN on open hardware with an embedded artificial intelligence (AI)-powered radio control.

In the following, handover (HO) process and parameters are briefly discussed.

A condition for sending a measurement report from a client device to a serving cell, which triggers the handover process, is generally based on a reference signal received power (RSRP) and per cell or per cell pair HO parameters. For example, the HO parameters may be defined per network entity or per network entity pair. For example, they may be defined per physical cell or cell pair, or per logical cell or cell pair (e.g., two logical slices from different physical cells), or per a single client device or client device groups. Herein, “cell” and “cell pair” are used as examples, but the disclosure is not limited to physical or logical cells or cell pairs. HO parameters include:
per cell pair cell individual offset (CIO): O_{n,m} denotes the cell individual offset (CIO) of a neighboring cell m specified in a source cell n, while O_{m,n} denotes the CIO of the cell n specified in the cell m. The cell pair CIOs are not reciprocal, i.e., O_{n,m} and O_{m,n} may be set to different values;
per cell A3 event offset (OFS) and hysteresis (HYS): the OFS and HYS in the cell n are denoted by OFSₙ and Hₙ, respectively; and
per cell time-to-trigger (TTT): Tₙ denotes the TTT defined in the cell n.

A UE k sends a measurement report triggering a handover from the cell n to the cell m if the following condition is fulfilled for a duration of time Tₙ:

$${M}_{m , k} + {O}_{n , m} \geq {M}_{n , k} + {O}_{m , n} + {OFS}_{n} + {H}_{n} \qquad ( Eq . 1 )$$

where M_{n,k} and M_{m,k} are signal measurements (e.g., RSRP) received in the UE k from the source cell n and the neighboring cell m respectively.

At least some HO optimization schemes may aim to reduce at least some of the following four HO events:
a too-late-handover (HOL): this may occur when a user is leaving the coverage area of its serving cell n towards the target cell m but the handover is not triggered which causes a radio link failure (RLF) of the UE;
a too-early-handover (HOE): this may occur when the HO decision is made too early. The neighboring cell cannot provide a sustainable signal quality to the user and an RLF happens right after the handover. The UE reconnects to the previous source cell of the handover. Random access failures to the target cell (due to too early triggering of handover) may also be considered as a part of the HOE;
a wrong-cell-handover (HOW): this may occur when a user is handed over from a source cell to a wrong target cell. An RLF is detected shortly after a successful handover to the target cell and then the user is connected to another neighboring cell that is different from the source cell; and
a ping-pong-handover (HOPP): this may occur when a user is handed over from the cell n to the cell m, but after a short time period the UE is handed over back from the cell m back to the cell n.

In the following, various example embodiments will be discussed. At least some of these example embodiments may allow network optimization based on distributed multi-agent machine learning with minimal inter-agent dependency.

At least some of these example embodiments may allow a distributed multi-agent deep reinforcement learning (DRL) scheme for a service level agreement (SLA)-guaranteed mobility robustness optimization (MRO) in which an agent may be defined based on an SLA coverage overlap region (SCOR for short) to minimize inter-agent dependency. The SLA coverage overlap region may be represented by a group of physical or logical cell boundaries and each agent may jointly optimize the CIOs and TTTs of the grouped cell boundaries. Herein, “logical” cell boundary refers to the SLA coverage overlap area between two logical network entities, and “cell boundary” refers either to a physical cell boundary or to a logical cell boundary (e.g., between two logical slices from different physical cells).

At least some of these example embodiments may allow grouping the cell boundaries and identifying the SCORs based on a partitioned or decomposed logical network graph or mobility relation graph (MRG). When a customer (e.g., a communication service provider, CSP) makes a query for pretrained models of a similar SCOR area, the profile of an MRG (e.g., an adjacent matrix or index of an MRG class, or other extracted features) may then be used as key to retrieve the SCOR-based artificial intelligence (AI) or machine learning (ML) model in a reference model database (DB).

Herein, the terms “partition” and “decompose” are used interchangeably. Herein, the terms “logical network graph” and “mobility relation graph” and “MRG” are used interchangeably. Herein, the terms “sub-MRG” and “SCOR-based subgraph” are used interchangeably.

Herein, when the term “user” is used to refer to a user mobility pattern or a user mobility distribution, it comprises a user equipment or a client device. When the term “user” is used to refer to a user who sends a query, it comprises a customer, such as a communications service provider (CSP) or an operator, who owns the data and network infrastructure and requests network optimization and transfer learning services in accordance with the disclosure.

At least some of these example embodiments may allow MRG generation in which users (e.g., CSPs) may request an MRG generation service to decompose a large-scale network to a set of subnetworks with minimum inter-subnetwork dependency. The service may provide the users the generated MRG and its sub-MRGs corresponding to the decomposed subnetworks. Such decomposition may provide a proper granularity of deploying distributed machine learning agents, which may achieve a good tradeoff between low model complexity and good model accuracy.

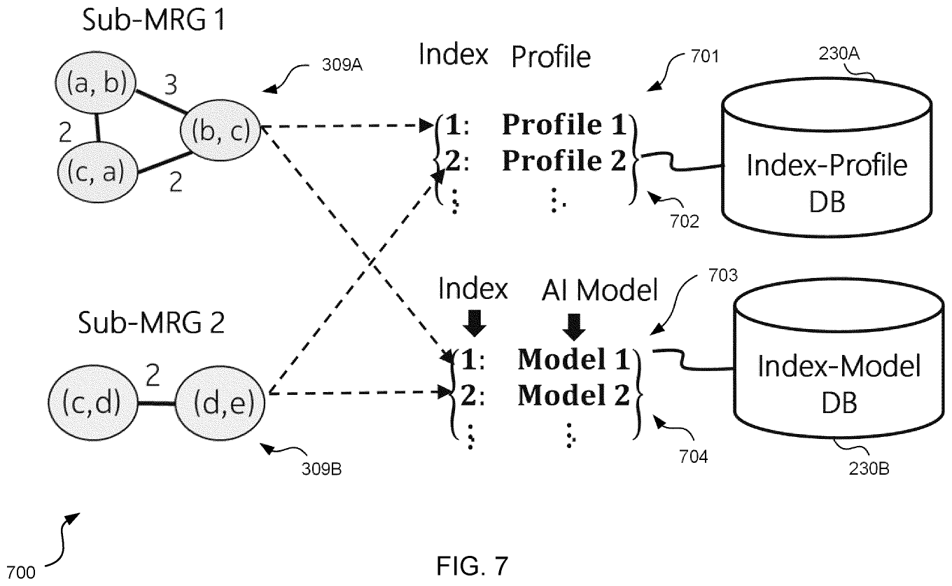

At least some of these example embodiments may allow building a SCOR-based reference model DB 230C in which by using the collected historical data, it is possible to obtain the SCORs and the SCOR-based subgraphs, namely, the corresponding sub-MRGs of the SCORs, and pre-train an MRO model for each SCOR. These sub-MRGs and the trained models may be used to construct the reference model DB 230C with a key-content structure. The profiles of the sub-MRGs (e.g., adjacent matrices) may be the keys, and the pre-trained models may be the contents. An alternative may be to build an index-profile DB 230A and an index-model DB 230B (as shown in diagram 700 of FIG. 7).

At least some of these example embodiments may allow ML model retrieval and transfer learning in which, when a user requests the transfer learning-based MRO service, it may first send the profile of the generated sub-MRGs as a query. Then, an MRG similarity analysis may compare the query with the keys in the reference model DB and return highly ranked keys. The transfer learning-empowered SON functions, e.g., an MRO function, may retrieve the highly ranked models, and either directly use the models for the user's network, or further fine-tune them with transfer learning. In this way, it is possible to build reusable and reproducible MRO models for a multi-vendor open environment.

In other words, at least some of these example embodiments may allow distributed multi-agent DRL for an MRO problem in which each agent may comprise a varying number of physical or logical network boundaries. The inter-agent dependencies may be minimized to improve robustness of the ML model by creating the agents with the decomposed network mobility graph.

Accordingly, at least some of these example embodiments may allow a transfer learning framework for SON functions such as the MRO, such that the ML models may be transferred between similar distributed agents, even when the agents comprise different numbers of grouped network entities (or boundaries between network entities).

Accordingly, at least some of these example embodiments may allow SON model profiling, storage, and management such that one can efficiently retrieve a SON model that was pre-trained in a similar (sub) network environment. The similarity between the relational network graph data may be analyzed. This approach may be beneficial, e.g., for SON use cases because it captures the strong interaction between the network entities within a local agent.

It is to be noted that the disclosure is not restricted to the MRO function only. Rather, it can also be applied to other SCOR-based SON functions, such as coverage and capacity optimization and mobility load balancing. Furthermore, it is to be noted that the reference model DB may be generalized to a reference container DB in which each pretrained SCOR-based SON function may be packaged in a container and saved in the DB. By sending a query including the profile of the sub-MRG, the user may retrieve a packaged pre-trained model, e.g., a Docker image, of a similar mobility and SLA coverage region.

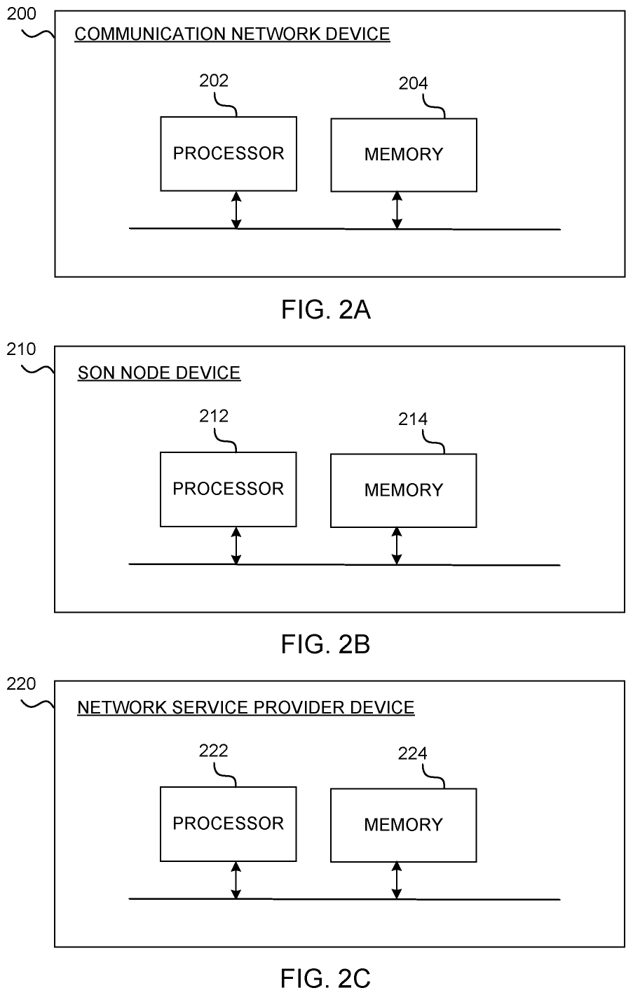

FIG. 2A is a block of diagram the communications network device 200, in accordance with an example embodiment.

The communications network device 200 comprises at least one processor 202 and at least one memory 204 including computer program code. The communications network device 200 may also include other elements, such as a transceiver configured to enable the communications network device 200 to transmit and/or receive information to/from other devices, as well as other elements not shown in FIG. 2A. In one example, the communications network device 200 may use the transceiver to transmit or receive signaling information and data in accordance with at least one cellular communication protocol. The transceiver may be configured to provide at least one wireless radio connection, such as for example a 3GPP mobile broadband connection (e.g., 5G and/or 6G). The transceiver may be configured to be coupled to at least one antenna to transmit and/or receive radio frequency signals.

Although the communications network device 200 is depicted to include only one processor 202, the communications network device 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The communications network device 200 may comprise an operations, administration, and maintenance (OAM) unit, a network node device (such as a base station), or a client device (such as a user equipment). The base station may include, e.g., a fifth-generation or sixth-generation base station (gNB) or any such device providing an air interface for client devices to connect to the wireless network via wireless transmissions.

The at least one memory 204 and the computer program code are configured to, with the at least one processor 202, cause the communications network device 200 at least to decompose or partition the communications network 110 into service level agreement (SLA) coverage overlap regions (SCORs) according to mobility relations between logical network entity (LNE) pairs within the communication network 110. The SCOR comprises at least one LNE pair.

Herein, the logical network entities are called “LNEs” for brevity. A network with a set of N LNEs may be denoted by [symbol] :={1, . . . , N}. E.g., for a network with C physical cells and S logical slices, each slice in each cell may be considered as an LNE, thus N=CS if each cell has S slices. It is to be noted that an even finer granularity of the LNEs may be considered, e.g., per Qos flow instead of per slice.

Herein, the term SLA (service level agreement) coverage overlap region (or SCOR for brevity) refers to a group of LNE pairs that is optimized such that the dependency between the SCORs is low. Since the logical network graph is decomposed into a group of SCORs according to the mobility relations between LNE pairs, while the mobility relations between LNE pairs changes from time to time, the numbers of the LNE pairs can be different from one SCOR to another, and the composition of the LNE pairs in a SCOR may be dynamic and adaptable to a changing environment. E.g., a SCOR may include cell boundaries A->B, B->A, B->C, C->B, while conventional optimizations are performed either per cell base (all one-directional cell boundaries related to a single cell, i.e., if a cell A has neighboring cells B, C, D, then they have a fixed number of boundaries A->B and A->C and A->D) or per cell pair-base (bidirectional cell boundaries of a single pair of cells, i.e., A->B and B->A).

For each LNE, a neighboring LNE list may be defined. E.g., if a cell b is in the neighboring cell list of a cell a and service for a slice s may be provided in both cells a and b, then the LNE (b,s) (representing slice s in cell b) may be included in the neighboring LNE list of LNE (a,s). For brevity of notation, a set of all LNE pairs may be defined as [symbol] :={(n, m): n, m∈ [symbol] }. It is to be noted that each tuple in [symbol] represents a directional LNE pair, e.g., from LNEn=(a, s) to LNEm:=(b,s). It is to be further noted that the previously mentioned logical cell boundary may be considered as service overlap regions of an LNE pair.

LNE pair-specific HO parameters may be defined. E.g., for each LNE pair (n,m)∈ [symbol] , the CIO and TTT (denoted by O_{n,m} and T_{n,m}, respectively) may be optimized. The HO criterion may remain in the same form as in Eq. (1), except that in replacing the cell pair, (n,m) are the LNE pair.

The following measurements for both LNE-specific and LNE pair-specific performance may be collected:
LNE-specific network states denoted by sₙ, ∀n∈ [symbol] , including but not limited to a per LNE number of users and load;
LNE-specific SLA-related QoS metrics denoted by qₙ, ∀n∈ [symbol] , including but not limited to a per LNE throughput and delay, and/or LNE pair-specific SLA-related QoS metrics denoted by q_{n,m}, ∀(n, m)∈ [symbol] ; and/or
LNE pair-specific HO-related metrics denoted by r_{n,m}, ∀(n, m)∈ [symbol] , including but not limited to per LNE pair ratios of HOE, HOL, HOW, and HOPP events.

For example, the communications network 110 may comprise a large-scale communications network. For example, at least some of the SCORs may further comprise a group of physical cell boundaries, a group of logical cell boundaries, or a group of physical cell boundaries and logical cell boundaries. For example, the LNEs may comprise cells, slices, and/or quality of service (QoS) flows.

In other words, each LNE may meet a predefined SLA for any mobility status. Thus, an objective may include guaranteeing the SLA services of all the LNEs while minimizing HO failures and unnecessary HOs by optimizing the LNE pair-specific CIOs o=[o_{n,m}: ∀(n, m)∈ [symbol] ]∈Ω and TTTs t:=[t_{n,m}: ∀(n, m)∈ [symbol] ]∈ [symbol] :

$${min}_{o ∈ Ω , t ∈ 𝒵} C ( r ( o , t ) ) \\ s . t . \\ U ( q ( o , t ) ) \geq η \qquad ( Problem 1 )$$

in which C(·) is a defined cost function based on HO-related metrics r(o, t):=[r_{n,m}(o, t): ∀(n, m)∈ [symbol] ], U(·) is a defined utility function based on QoS-related metrics q(o, t):=[q_{n,m}(o, t): ∀(n, m)∈ [symbol] ], and η is a threshold for QoS utility.

It is to be noted that the disclosure includes but is not restricted to the optimization of per LNE-pair HO parameters CIO and TTT. The same technique may be applied to optimize a broader class of HO parameters, e.g., HO parameters in idle mode qOffset and TReselEutra. Moreover, HO parameters with different granularities may be optimized. For example, the disclosure is also applicable to an MRO scenario where TTT is defined per cell and CIO is defined per cell pair.

In other words, in a distributed multi-agent DRL scheme for MRO an agent may be defined based on the SLA coverage overlap region (SCOR) to minimize the inter-agent dependency.

For a large-scale communications network, a centralized learning approach for MRO may not be practical because of its intractable high-dimensional network state and action spaces. In contrast to the centralized scheme, the distributed scheme decomposes the large-scale network to groups of LNEs and applies a machine learning agent to each of the group. The distributed multi-agent approach may reduce the complexity of the ML model and may speed up the learning speed.

At least in some embodiments, LNE pairs in a SCOR comprising at least two directional LNE pairs may be strongly coupled, and dependency between the SCORs may be low.

Herein, LNE pairs A and B are “strongly coupled” if the HO and QoS performance of A are strongly affected by the HO parameters in B, or the HO and Qos performance of B are strongly affected by the HO parameters in A. Further, herein SCORs X and Y have “low dependency/interaction” if the HO parameters of the LNE pairs in X have a low effect on the overall HO and Qos performance of the LNE pairs in Y, and the HO parameters in Y have a low effect on the overall HO and QoS performance of the LNE pairs in X.

In other words, a distributed multi-agent MRO scheme with minimal inter-agent dependency may be enabled by decomposing the large-scale network into multiple SCORs, such that the LNEs within the same SCOR are strongly coupled, while the interaction between LNEs in the neighboring SCORs is low.

At least in some embodiments, the at least one memory 204 and the computer program code may be further configured to, with the at least one processor 202, cause the communications network device 200 to decompose the communications network 110 into the SCORs by generating a logical network graph corresponding to the communications network 110 and representing the mobility relations between the LNE pairs, and by decomposing the logical network graph into subgraphs, such that the subgraphs represent SCORs comprising strongly coupled LNE pairs. For example, the generating of the logical network graph may comprise generating the logical network graph based on historical LNE data, statistical mobility data, or an SLA coverage map.

At least in some embodiments, vertices of the logical network graph may comprise the LNE pairs, and weights of edges of the logical network graph may reflect a mobility relationship between two LNE pairs.

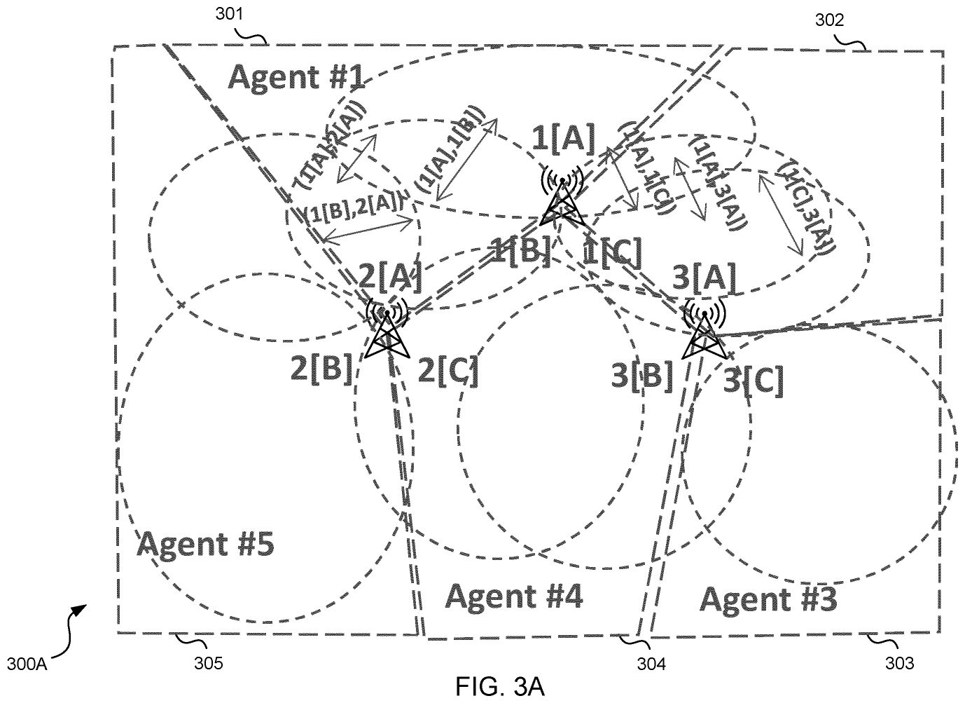

Diagram 300B of FIG. 3B illustrates deriving a mobility relation graph (MRG) 308 and SCORs from an LNE log history 306. In other words, to generate an MRG 308 and to decompose it to the SCORs from the LNE log history 306, a logical network graph G=(V,E) may be derived based on mobility relations between LNE pairs. Herein, it is also called the MRG. The vertices of the graph may be the LNE pairs (logical cell boundaries), and the weights of the edges may reflect the mobility relationship between two LNE pairs, as shown in diagram 300B. From Eq. (1), it is known that CIO_{n,m} and CIO_{m,n} are strongly coupled. Thus, the unidirectional LNE pairs may be used as the vertices of the MRG, i.e., boundary (m, n) and (n, m) are always jointly optimized.

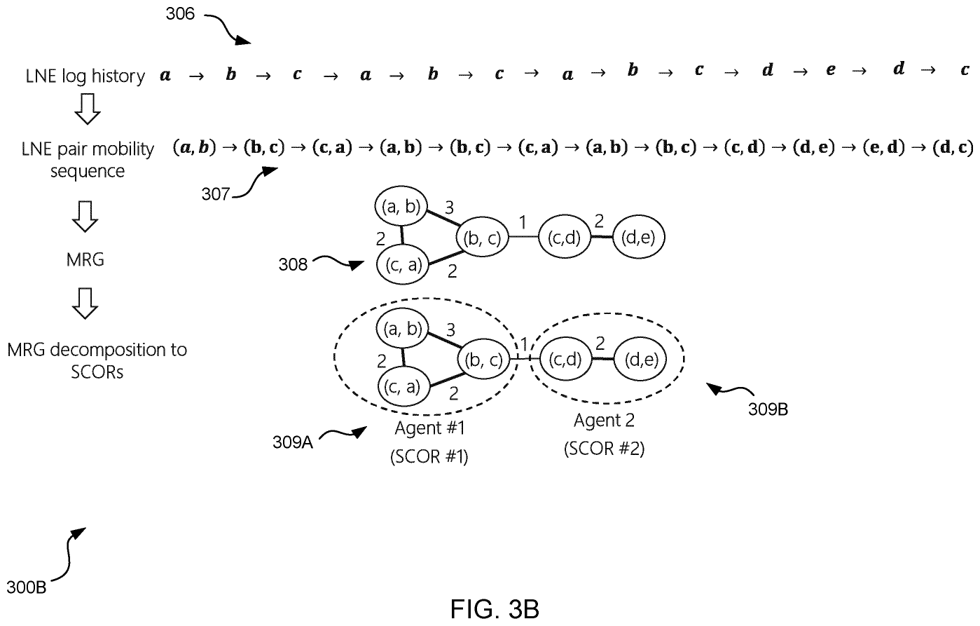

It may be assumed that an LNE log history 306 of all users during a time period can be collected. Then, as shown in FIG. 3B, the steps of generating the MRG 308 and its decompositions may be as follows:
1. from the log history 306, e. g., a sequence of LNE identities (IDs), obtain a sequence 307 of LNE pairs. E.g., the sequential logs of LNEs a→b→c corresponds to sequential LNE pairs (a,b)→(b,c),
2. use the unique set 307 of LNE pairs as the vertices of the MRG 308,
3. count the number of transitions between each LNE pairs and use the number as weights of the edges of the MRG 308, and
4. use a graph decomposition/partition scheme (e.g., spectral partitioning) to decompose the MRG 308 to subgraphs 309A, 309B (herein also called sub-MRGs), each representing a SCOR comprising strongly coupled LNE pair(s), as shown in diagram 400 of FIG. 4 (which illustrates the communications network 110 partitioned to SCORs 401, 402 and their corresponding subgraphs 309A, 309B). For each SCOR, a machine learning agent may be defined to solve the MRO problem within the SCOR.

Examples of the graph decomposition/partition schemes include but are not limited to spectral partitioning in which a partition is derived from approximate eigenvectors of an adjacency matrix, and spectral clustering which groups graph vertices using an eigen-decomposition of a graph Laplacian matrix.

It is to be further noted that in case LNE logs data is not available, it is possible to exploit the HO statistics, adjacent relationship, and a coverage map to generate an alternative type of MRG, with the LNEs as vertices and LNE pair specifying the edges.

At least in some embodiments, the at least one memory 204 and the computer program code may be further configured to, with the at least one processor 202, cause the communications network device 200 at least to perform generating a profile for at least some of the subgraphs. The profile may comprise an adjacency matrix or an adjacency list representing the respective subgraph.

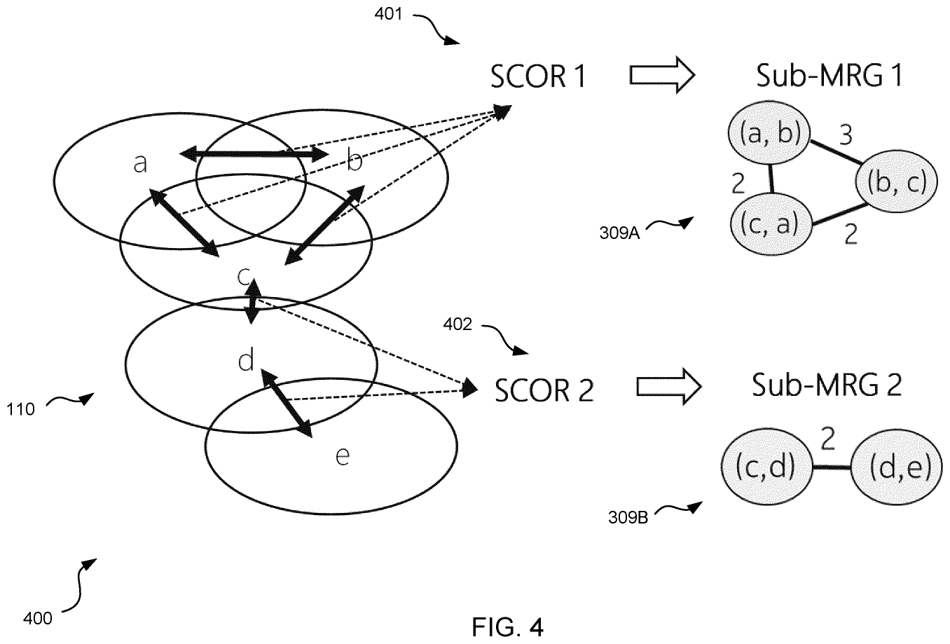

In other words, a representation of a graph may include an adjacency matrix and/or an adjacency list. The adjacency matrix and list may be built based on the relation between the vertices. That is, the adjacency matrix may indicate the weight of an edge between each pair of vertices, and the adjacency list may collect for each vertex the connected vertices and the edge weights. Since in the disclosure there may be strongly coupled LNE pairs within the agent, the number of edges may be more than the number of vertices. Thus, an adjacent matrix or list may be chosen to represent the sub-MRG. An example is given in diagram 500 of FIG. 5 (which illustrates an example representation of a subgraph 309A with an adjacency matrix 501 or an adjacency list 502).

At least in some embodiments, each profile may further comprise a number of vertices, a number of edges, a number of involved LNEs, a degree distribution, a distribution of edge weights, a distribution of summed weights of edges incident to a vertex, or at least one LNE specific feature for the respective subgraph including at least one of a deployment type, an LNE type, an associated user mobility distribution, position information, and/or an LNE load state.

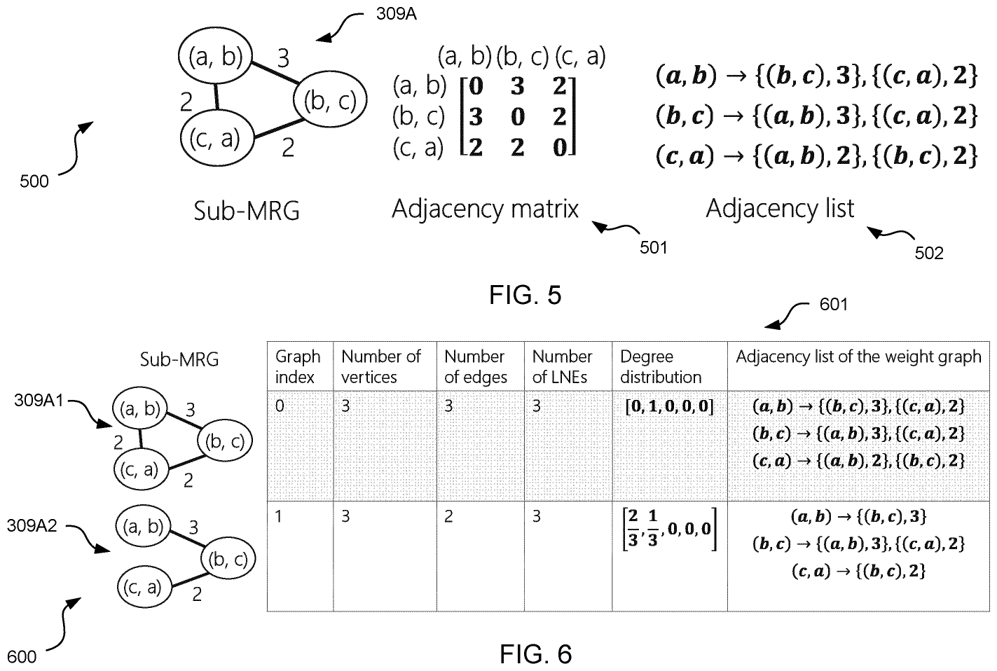

In other words, for more efficient profile similarity analysis and model retrieval, prescreening may be performed based on some simple features to reduce the size of the searching set of adjacency matrices/lists for similarity analysis. Such optional features may include, e.g.:
a number of vertices,
a number of edges,
a number of involved LNEs,
a degree distribution: a degree of a vertex is the number of edges that are incident to it. Assuming the maximum number of incident edges of any vertex to be E, the degree distribution is an E-dim vector where the i-th dim is the probability of that vertex having i vertices. As shown in diagram 600 of FIG. 6 (which illustrates an example of sub-MRG profiling), for the upper sub-MRG 309A1, the degrees are 2 for all the three vertices, i.e., with a probability 1 the vertex has 2 incident edges, and with E=5, the degree distribution is [0,1,0,0,0]. For the lower sub-MRG 309A2, the degrees of the vertices (a, b), (b, c), (c, a) are 1,2, 1, respectively. I.e., there is a ⅔ probability that a vertex has a degree of 1 and a ⅓ probability that a vertex has a degree of 2. The degree distribution is then [⅔,⅓,0,0,0],
other features can be also considered such as:
   a number of involved LNEs: e.g., for both sub-MRGs in FIG. 6, the number of the involved LNEs is 3, i.e., LNEs {a, b, c},
   a distribution of the edge weights,
   a distribution of summed weights of the edges incident to a vertex.

An example of an indexed sub-MRG profile is shown in the table 601 in FIG. 6.

In case the MRG's vertices are defined by LNEs, while their edges are defined by LNE pairs (LNE boundaries), more LNE-specific features may be included into the profile, e.g.:
a deployment type: dense urban, urban, suburban and rural,
an LNE type: e.g., for physical network entities such as macro, micro, pico and femto cells,
an associated user mobility distribution,
position information: outdoor, indoor,
LNE load conditions: highly utilized, moderately utilized, underutilized.

The at least one memory 204 and the computer program code are further configured to, with the at least one processor 202, cause the communications network device 200 at least to assign a machine learning agent to each of the decomposed SCORs.

Each machine learning agent is configured to apply a deep reinforcement learning model (DRL model) to solve an optimization problem related to a self-organizing network (SON) function within its assigned SCOR. The DRL model may be customizable to each machine learning agent, e.g., based on a similarity analysis between subgraphs of the generated logical network graph. Accordingly, at least in some embodiments, based on the similarity analysis between SCOR-based subgraphs, a pretrained model in one machine learning agent may be retrieved, reused, and/or customized for another agent. For example, a customized DRL model may comprise a transfer learning enhanced DRL model (TL-DRL model).

Diagram 300A of FIG. 3A illustrates an example of a SCOR and SCOR-based agents. More specifically, diagram 300A of FIG. 3A illustrates an example of decomposed SCORs and their corresponding agents, with each SCOR comprising a group of strongly coupled LNE pairs. In the example of FIG. 3A, each of Agent #1, Agent #2, Agent #3, Agent #4, and Agent #5 optimizes HO parameters within an SLA coverage overlap region 301, 302, 303, 304, 305, respectively, e.g., for a group of highly dependent cell boundaries of cells 1[A], 1[B], 1[C], 2{A], 2[B], 2[C], 3[A], 3[B], 3[C]. In the example of FIG. 3A, there are three sites: Site 1, 2, 3. Each site has three cells, e.g., Site 1 has cells 1[A], 1[B], 1[C], etc. The circles represent coverage areas of the cells. The arrows represent coverage boundaries between two cells. For example, the arrows for Agent #1 represent cell boundaries of cell pairs (1[A], 1[B]), (1[A], 2[A]), (1[B], 2[A]), and the arrows for Agent #2 represent cell boundaries of cell pairs (1[A], 1[C]), (1[A], 3[A]), (1[C], 3[A]).

In other words, with the decomposed SCORs, it is possible to use distributed DRL approaches to optimize, e.g., HO parameters within each SCOR in a distributed manner, i.e., to solve Problem 1 for each SCOR independently. Due to the weak dependencies between the agents, the distributed multi-agent DRL may converge faster, and the learning may be more robust. Given a local agent ioptimizing a set of Kᵢ LNE pairs (boundaries), denoted by [symbol] :={(nₖ, mₖ): k=1, . . . , Kᵢ; (nᵢ, mᵢ)∈ [symbol] }, the involved INEs may be denoted by [symbol] with | [symbol] |=Nᵢ.

At least in some embodiments, states of the assigned machine learning agent(s) may comprise LNE-specific metrics, LNE pair-specific metrics, and/or contextual information for capturing at least one of temporal or spatial correlations.

In other words, the states may be defined in each local agent, e.g., as follows:
state sᵢ: e.g., the following features may be included in the state:
   LNE-specific metrics: including but not limited to the following per LNE metrics (or the extracted statistics over all involved LNEs): number of UEs, load, distribution of received signal strengthrelated measurements (e.g., channel quality indicator (CQI), RSRP distribution or reference signal received quality (RSRQ)), QoS-related metrics (e.g., throughputs, delay), and/or other LNE-specific configurations (e.g., if an LNE is defined as a slice in a cell, the slice resource budget may be one of the slice management configurations);
   LNE pair-specific metrics: including but not limited to the following per LNE pair metrics: HO-related metrics computed from counts of HO events, such as HOL, HOE, HOW, HOPP, and HO attempt (HOA), e.g., the ratio of the number of HOL, HOE, HOW, HOPP events to the number of HOAs, and/or LNE pair-specific QoS-related metrics (e.g., per cell boundary averaged throughputs and delay);
   other context information: to capture temporal or spatial correlations, categorical context information may be included, e.g., time index (hour of the day, weekday, or weekend), type of region (e.g., rural or urban). Such categorical data may be included in the state with one-hot encoding or categorical embedding.

At least in some embodiments, an action space of the assigned machine learning agent(s) may comprise a discrete action space or a continuous action space.

In other words, the actions may be defined in each local agent, e.g., as follows:
action aᵢ: e.g., two different models of DRL with different definitions of actions may be considered:
   model I with continuous CIO and TTT values: the policy of DRL directly provides the proto action, i.e., the CIO and TTT values of all LNE pairs in agent i denoted by aᵢ=[(oₙ_{ₖ}_{,m}_{ₖ}, oₘ_{ₖ}_{,n}_{ₖ}, tₙ_{ₖ}_{,m}_{ₖ}, tₘ_{ₖ}_{,n}_{ₖ}): k=1, . . . , Kᵢ], in a continuous space. However, the CIOs and TTTs may be selected from a defined discrete set, e.g., the pool of CIO values [symbol] :={−24,−23, . . . ,23,24} and the pool of TTT values
[symbol] :=(0.004, 0.064, 0.080, 0.1, 0.128, 0.16, 0.256, 0.320, 0.48, 0.512, 0.640, 1.024, 2.56, 5.12}.

This means that when working in discrete space, oₙ_{ₖ}_{,m}_{ₖ}∈ [symbol] and tₙ_{ₖ}_{,m}_{ₖ}∈ [symbol] for k=1, . . . , Kᵢ, the action space is ( [symbol] × [symbol] )^{2K}^{ᵢ}. E.g., with only Kᵢ=2 pairs of LNEs in the agent, it is possible to have (49·14)⁴ combinations of possible discrete actions, which may be intractable with value-based algorithms (such as deep-Q networks (DON)) in a discrete space. Working in a continuous space may reduce the dimension of the output action and thus reduce the model complexity, e.g., by using the policy-based or actor-critic-based DRL algorithms. When interacting with the environment, the proto action may be projected in continuous space to the defined discrete action by finding its nearest neighbor in the discrete space;
model II with a discrete step size of CIO and TTT adjustment: to work with the discrete action space the action space may be reduced first. One option is to optimize the step size of the adjustment of CIO and TTT instead of the actual CIO and TTT values. For example, an action aᵢ=[(Δoₙ_{ₖ}_{,m}_{ₖ}, Δoₘ_{ₖ}_{,n}_{ₖ}, Δtₙ_{ₖ}_{,m}_{ₖ}, Δtₘ_{ₖ}_{,n}_{ₖ}): k=1, . . . , Kᵢ] may be defined where the step size for CIO is Δo_{n,m}∈Λ^{(CIO)} and the step size for TTT is Δt_{n,m}∈Λ^{(TTT)}, for any (n, m)∈ [symbol] . A small step size set, e.g., Λ^{(CIO)}:={−2, −1, 0, 1,2} and Λ^{(TTT)}:={−1,0,1} may be defined, and the discrete action space is (Λ^{(CIO)}×Λ^{(TTT)})^{2K}^{ᵢ}. With Kᵢ=2 pairs of LNEs in the agent, there are only (5·3)⁴ possible actions. In this way, both the value-based DRL algorithms (e.g., DON) and the policy- or actor-critic-based DRL algorithms may be considered.

At least in some embodiments, rewards for the assigned machine learning agent(s) may be based on LNE pair—specific handover performance metrics, LNE-specific quality of service, Qos, performance metrics, and/or LNE pair—specific QoS performance metrics. Additionally/alternatively, the rewards for the assigned machine learning agents may be based on layer 2 cell based scheduling performance metrics and/or service level agreement success rates.

In other words, the rewards may be defined in each local agent, e.g., as follows:
reward Rᵢ: the SLA-guaranteed MRO may take both HO performance and SLA-related QoS performance into account. Thus, the reward Rᵢ may be computed based on, e.g., the following metrics:
LNE pair-specific HO performance metrics: negative HO cost computed from the HOL, HOE, HOW, and HOPP ratios. One example of the HO cost is the weight sum of the ratios of different HO events:

$${c}_{i}^{( HO )} = \frac{1}{{K}_{i}} {\sum }_{( n , m ) ∈ {𝒫}_{i}} {w}_{n , m}^{( HOL )} {r}_{n , m}^{( HOL )} + {w}_{n , m}^{( HOE )} {r}_{n , m}^{( HOE )} + {w}_{n , m}^{( HOW )} {r}_{n , m}^{( HOW )} + {w}_{n , m}^{( HOPP )} {r}_{n , m}^{( HOPP )} , \qquad ( Eq . 2 )$$

in which r^{(HOL)}, r^{(HOE)}, r^{(HOW)}, r^{(HOPP)} and w^{(HOL)}, w^{(HOE)}, w^{(HOW)}, w^{(HOPP)} are the ratios and weights for HOL, HOE, HOW, and HOPP events, respectively;
   LNE-specific QoS performance metrics: a QoS reward computed from throughput and delay. For example, given the throughput requirement ϕₙ* and delay requirement dₙ* for each LNE n∈ [symbol] , the QoS reward in agent i may be computed as:

$${q}_{i}^{( QoS )} = {\sum }_{n ∈ {𝒩}_{i}} {w}_{n}^{( QoS )} min \{ \frac{{ϕ}_{n}}{{ϕ}_{n}^{*}} , \frac{{d}_{n}^{*}}{{d}_{n}} , 1 \} = 1 \qquad ( Eq . 3 )$$

in which ϕₙ and dₙ are the achieved throughput and delay, respectively. qᵢ^{(Qos)} is a weighted sum of the QoS satisfaction level of all LNEs involved in agent i. It is to be noted that the QoS satisfaction level is upper-bounded by 1, i.e.,

$$min \{ \frac{{ϕ}_{n}}{{ϕ}_{n}^{*}} , \frac{{d}_{n}^{*}}{{d}_{n}} , 1 \} = 1$$

if the throughout is higher than required on ϕₙ≥ϕₙ* on and the delay is lower than required dₙ≤dₙ*. The weight wₙ^{(QoS)} reflects the importance/priority of LNE n. It is possible to make wₙ^{(Qos)} proportional to the number of UEs/services associated to LNE n, e.g.,

$${w}_{n}^{( QoS )} = \frac{{N}_{n}^{( UE )}}{{\sum }_{l ∈ {𝒩}_{i}} {N}_{1}^{( UE )}}$$

such that qᵢ^{(QoS)} is the averaged QoS satisfaction level over all UEs/services involved in agent i. Other QoS rewards may also be utilized, such as applying a utility function to address the fairness or priority of different network entities and/or QoS metrics.

The overall reward Rᵢ may be the weight sum of the negative HO cost and the QoS reward:

$${R}_{i} = {w}^{( QoS )} {q}_{i}^{( QoS )} - {w}^{( HO )} {c}_{i}^{( HO )} \qquad ( Eq . 4 )$$

It is to be noted that the disclosed ML model may also be applied to conventional MRO without SLAawareness, by excluding the SLA-related metrics in the network states and QoS performance metrics in the reward computation.

Various DRL algorithms may be utilized, including deep Q-learning (when discrete action space is relatively small, e.g., with the above disclosed model II where action is defined as a discrete step size of CIO and TTT adjustment), policy-based algorithms such as PPO, and actor-critic-based algorithms such as deep deterministic policy gradient (DDPG) (which may be used for both models I and II).

It is to be noted that [symbol] ∩ [symbol] =Ø for i≠j because all the LNE pairs are partitioned to separate SCORs. However, an LNE may be involved in several neighboring agents, e.g., an LNE n may have one boundary (n, m) grouped into agent 1 and another boundary (n,l) grouped into agent 2. Thus, in the SLA-guaranteed MRO scheme, when LNE-specific KPIs and QoS metrics are included in the state sᵢ and the reward Rᵢ, there are still QoS dependencies between the agents, although by MRG decomposition the mobility dependencies may be reduced. Thus, a possible coordination scheme may be designed for multi-agent DRL to ensure the consensus, by adding new features extracted from the neighboring agents' states.

At least in some embodiments, the SON function may comprise a mobility robustness optimization (MRO) function, a coverage and capacity optimization function, or a mobility load balancing function. For example, the MRO function may comprise optimization of one or more handover parameters.

At least in some embodiments, the at least one memory 204 and the computer program code may be further configured to, with the at least one processor 202, cause the communications network device 200 at least to obtain the DRL model as pretrained from a SON node device 210.

FIG. 2B is a block diagram of the SON node device 210, in accordance with an example embodiment.

The SON node device 210 comprises at least one processor 212 and at least one memory 214 including computer program code. The SON node device 210 may also include other elements, such as a transceiver configured to enable the SON node device 210 to transmit and/or receive information to/from other devices, as well as other elements not shown in FIG. 2B. In one example, the SON node device 210 may use the transceiver to transmit or receive signaling information and data in accordance with at least one cellular communication protocol. The transceiver may be configured to provide at least one wireless radio connection, such as for example a 3GPP mobile broadband connection (e.g., 5G or 6G). The transceiver may be configured to be coupled to at least one antenna to transmit and/or receive radio frequency signals.

Although the SON node device 210 is depicted to include only one processor 212, the SON node device 210 may include more processors. In an embodiment, the memory 214 is capable of storing instructions, such as an operating system and/or various applications. Furthermore, the memory 214 may include a storage that may be used to store, e.g., at least some of the information and data used in the disclosed embodiments.

Furthermore, the processor 212 is capable of executing the stored instructions. In an embodiment, the processor 212 may be embodied as a multi-core processor, a single core processor, or a combination of one or more multi-core processors and one or more single core processors. For example, the processor 212 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 212 may be configured to execute hard-coded functionality. In an embodiment, the processor 212 is embodied as an executor of software instructions, wherein the instructions may specifically configure the processor 212 to perform the algorithms and/or operations described herein when the instructions are executed.

The memory 214 may be embodied as one or more volatile memory devices, one or more non-volatile memory devices, and/or a combination of one or more volatile memory devices and non-volatile memory devices. For example, the memory 214 may be embodied as semiconductor memories (such as mask ROM, PROM (programmable ROM), EPROM (erasable PROM), flash ROM, RAM (random access memory), etc.).

The at least one memory 214 and the computer program code are configured to, with the at least one processor 212, cause the SON node device 210 at least to receive from the communications network device 200 a request for a pretrained DRL model for use in solving an optimization problem related to a SON function within a SCOR. The request comprises at least one profile of at least one e subgraph of a logical network graph representing mobility relations between LNE pairs. As discussed above in more detail, the SCOR comprises at least one LNE pair, and the at least one subgraph corresponds to the SCOR.

The at least one memory 214 and the computer program code are further configured to, with the at least one processor 212, cause the SON node device 210 at least to determine a pretrained reference DRL model from a model database 230A, 230B, 230C by a similarity analysis based on the profile of the subgraph.

The at least one memory 214 and the computer program code are further configured to, with the at least one processor 212, cause the SON node device 210 at least to transmit the determined pretrained reference DRL model to the communications network device 200.

At least in some embodiments, the similarity analysis may comprise a relational similarity analysis between the at least one subgraph in the received at least one profile and subgraphs associated with the pretrained reference DRL models stored in the model database 230A, 230B, 230C. Accordingly, at least in some embodiments, the disclosed transfer learning approaches may preserve relational similarity between SCORs and allow model transfer between SCOR-based agents with a same or different number of nodes and edges.

At least in some embodiments, the at least one memory 214 and the computer program code may be configured to, with the at least one processor 212, further cause the SON node device 210 to customize the determined reference DRL model, and to transmit the customized DRL model to the communications network device 200. For example, the customized DRL model may comprise a TL-DRL model.

In other words, it may be assumed that a user sends a query of a sub-MRG G_{*}=(V_{*}, E_{*}) with N_{*}^{(V)} vertices (i.e., LNE-pairs) and N_{*}^{(L)} involved LNEs, and requests a “target” DRL model M_{*}(G_{*}) customized to the SCOR characterized by G_{*}. The network service provider device 220 may identify the sub-MRG Gₛ=(Vₛ, Eₛ) similar to Gt in the index-profile DB, with Nₛ^{(V)} vertices and Nₛ^{(L)} involved LNEs, and retrieve Gₛ's corresponding pretrained “source” model Mₛ (Gₛ) in the index-model DB.

At least in some embodiments, the at least one memory 214 and the computer program code may be configured to, with the at least one processor 212, further cause the SON node device 210 to prescreen the profile(s) of the subgraph(s) based on one or more prescreening parameters to determine one or more candidate pretrained reference DRL models. In this case, the determining of the pretrained reference DRL model may be performed on the determined one or more candidate pretrained reference DRL models.

In other words, for searching and sub-MRG similarity analysis, e.g., at least some of the following steps may be utilized:
profile pre-screening: because the graph similarity analysis costs more computational effort, simple features (e.g., the number of vertices and edges, number of involved LNEs, and the distribution of degree, as shown in FIG. 6) may first be used to pre-screen the profiles and find a reduced candidate set of “roughly” similar “source” profiles, denoted by [symbol] ₛ:={Gₛ_{ᵢ}: i=1, 2, . . . }. Various distance measures may be applied, including, e.g., a Euclidean distance between the numbers of nodes and edges, and/or Kullback-Leibler divergence of the degree distribution. At least in some embodiments, only the candidate sub-MRGs with numbers of the vertices and the involved LNEs no less than (if not the same as) those of the sub-MRG in query, i.e., Nₛ^{(V)}≥N_{*}^{(V)} and Nₛ^{(L)}≥N_{*}^{(L)} may be pre-screened. In this way, even if the sub-MRG sharing the same numbers of LNE-pairs and involved LNEs cannot be found, the retrieved source model Mₛ (Gₛ) is given some degree of information redundancy to learn M_{*}(G_{*}).
graph similarity measure: after the pre-screening, a small set of sub-MRGs may be derived to be compared with the sub-MRG sent in the query. Then, e.g., classical graph similarity analysis techniques may be applied to find the most similar one(s). Such techniques may be classified into three categories: edit distance/graph isomorphism, feature exaction, and iterative methods.

If a user sends a query of a set of sub-MRGs generated from its own network environment, it can eithe apply directly the retrieved pretrained SON models or further request a transfer learning service to customize the retrieved model to its own network environment.

It is to be noted that it may be likely that Nₛ^{(V)}≠N_{*}^{(V)} and Nₛ^{(L)}≠N_{*}^{(L)}, i.e., even the most similar sub-MRGs do not necessarily have the same number of vertices and edges as the ones in the query, while a direct application of the ML model prefers the same size of vertices, namely, the same dimension of the LNE pair-specific action. Moreover, the same number of involved LNEs may also be preferred, such that the input network state can have the same dimension. Thus, after retrieving the model, even though Gₛ is very similar to the G_{*} in the query, a transfer learning scheme may be needed for better customization.

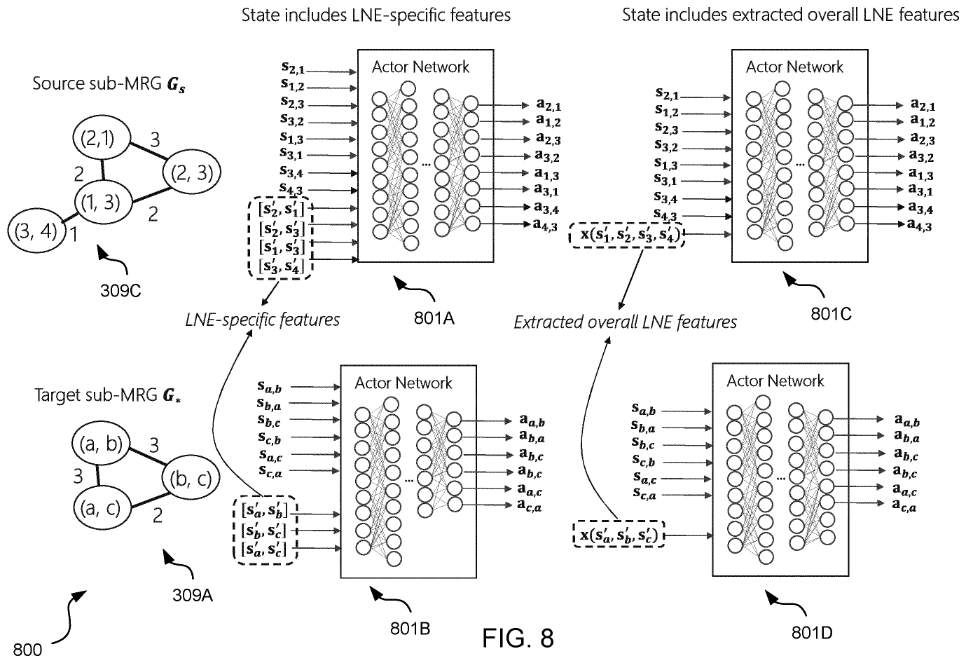

Diagram 800 of FIG. 8 illustrates an example of actor networks 801A-801D in a DRL architecture in which the source model has higher dimensions of action and state than the target model. s_{n,m} denotes the LNE pair-specific features of the boundary (n, m), e.g., HO failure ratio between LNE boundary (n, m), while [sₙ^{′, s}ₘ′] denotes the LNE-specific state of LNE n and LNE m, e.g., sₙ′ and sₘ′ may include the load of LNE n and m, respectively. The concatenated [sₙ′, sₘ′] corresponds to the LNE boundary (n, m), providing additional information for HO decision making between n and m.

In the following, state and action dimension matching is discussed. To enable the transfer learning from one model to another, the features in the state and action in M_{*} (G_{*}) may first be ordered such that the dependencies between the features are consistent with the defined state and action in Mₛ (Gₛ):
ordering the LNE within each LNE pair: because the HO parameters are directional, e.g., CIO_{n,m}≠CIO_{m,n}, the LNEs in each LNE pair may be ordered such that the order of the action outputs are consistent in both the source and target model. The ordering may be based on summed edge weights related to the LNE (an edge reflects an intermediate LNE between two neighboring LNE pairs). E.g., in FIG. 8, in the source graph G, 309C within the LNE pair (2,1), LNE 2 may be put first because the edge (2,1)-(2,3) shares the LNE 2 and has a higher weight 3, while the edge (2,1)-(1,3) shares the LNE 1 and has a lower weight 2. Alternative schemes to order the LNEs in an LNE pair may include ranking them based on selected LNE features, e.g., per-LNE average load or average received signal strength.
finding matching LNE pairs between G_{*} and Gₛ: for each vertex (LNE pair) in the target sub-MRG G_{*}, denoted by v∈ [symbol] (G_{*}), where [symbol] (·) denotes the set of all vertices in a graph, its matching vertex in the source sub-MRG G_{*}, denoted by u∈ [symbol] (Gₛ) needs to be found. Thus, the problem is to find:

∀v∈ [symbol] (G_{*}),u*(v)= [symbol] d(F(v),F(u))
in which d(F(v), F(u)) is the distance measure between the extracted features, denoted by F(v) and F(u), of the vertices u and v.

The rationale behind this is that the two vertices in two graphs are similar if their neighbors and the edges to the neighbors are similar. Thus, the distance measure of the extracted features of the neighboring vertices and edges may be computed to find the most similar vertex in Gₛ to a given vertex in G_{*}.

Table I below gives an example of the matched order of LNE pairs, as well as the LNEs within each LNE pair, between the source 309C and target 309A sub-MGRs in FIG. 8.

TABLE I
Matched order of LNE pairs and LNEs
Match order of LNE pairs & matched order of LNEs within each pair

(a, b) − (2, 1)
(b, c) − (2, 3)
(a, c) − (1, 3)
None − (3, 4)

In the following, transfer learning from a source model to a target model is discussed. With the matched order of LNE pairs and LNEs within each pair, the order of state and action features may be sorted such that the inter-feature dependencies in the source and target model are consistent, as shown in FIG. 8. It is to be noted that in FIG. 8 the actor network 801A801D is used as an example for the actor-critic DRL algorithms, but the same approach may be used in critic network and other DRL architectures, such as DON.

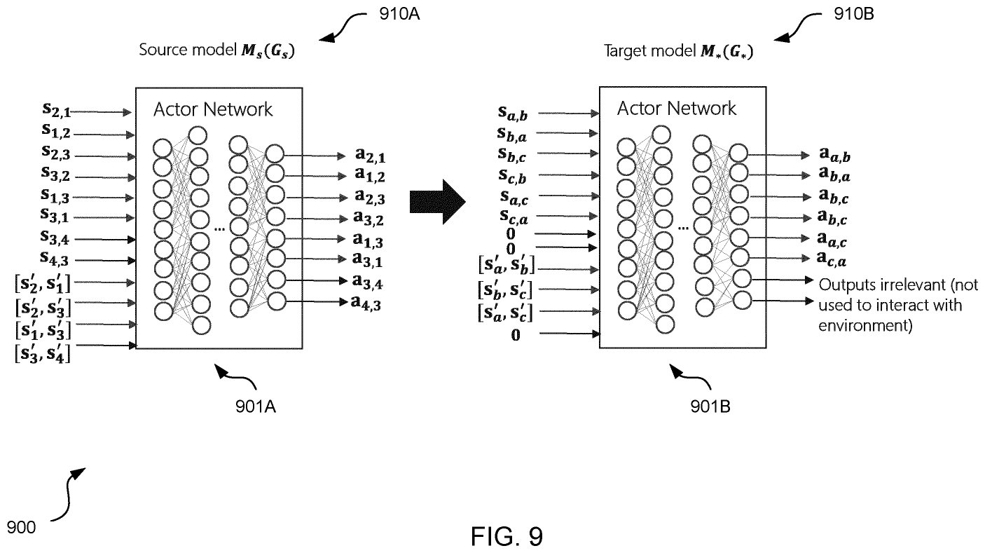

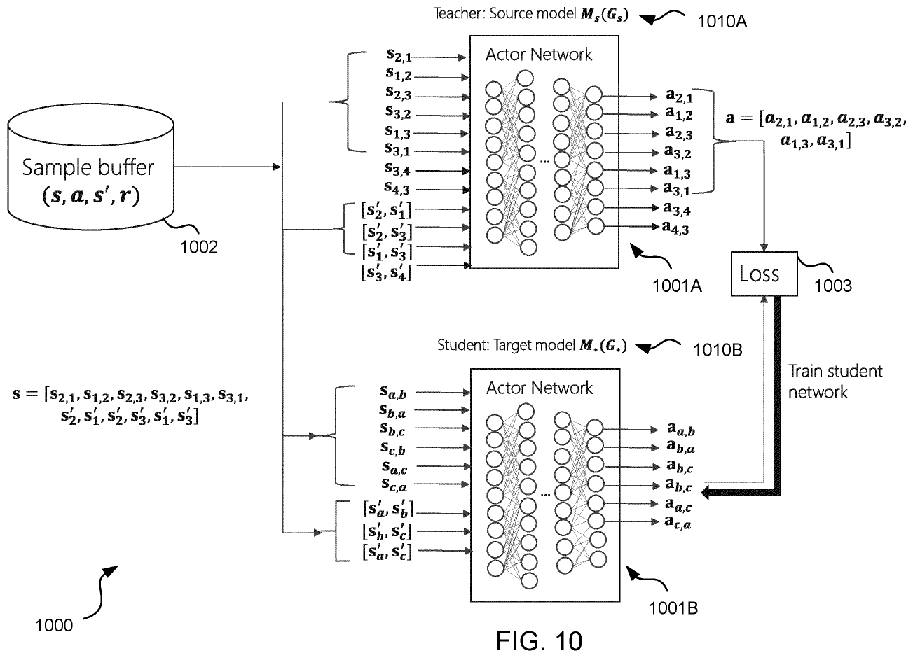

In the following, examples of transfer learning schemes are provided:
if Nₜ^{(V)}=Nₛ^{(V)} and Nₜ^{(L)}=Nₛ^{(L)}, the architecture of Mₜ(Gₜ) is the same as Mₛ(Gₛ) because they have the same dimension of state s and action a,
   direct application: The user may simply retrieve and apply the source model, i.e., Mₜ(Gₜ)=Mₛ(Gₛ),
   finetuning: if the user requests transfer learning service, standard transfer learning approaches may be used to customize the retrieved model Mₛ(Gₛ) to Mₜ(Gₜ). One option is to use finetuning, which initializes the neural network by loading the weights, i.e., M_{*}⁽⁰⁾(G_{*})=Mₛ⁽⁰⁾(Gₛ), then finetuning the weights of partial or all layers of Mₜ(Gₜ) by training with the data in target domain (user's data and network environment),
if Nₜ^{(V)}>Nₛ^{(V)} and/or Nₜ^{(L)}>Nₛ^{(L)}, the source model has higher dimensions of action and state than the target model, as shown in FIG. 8,
   direct application: the source model Mₛ(Gₛ) may be directly applied with the following modifications (an example is shown in diagram 900 of FIG. 9 which illustrates an example of direct application of Mₛ (Gₛ) 910A for a target model 910B, with actor network 901A, 901B, respectively):
      1. setting the states related to the LNE-pairs irrelevant to G_{*} (e.g., LNE pair (3,4) in Table I) to be vectors of zeros. The rationale behind this is to treat the LNE pairs irrelevant to G_{*} as if they are “virtually” a part of G_{*}, but with zero users/services and zero mobility events.
      2. use the actions of existing LNE pairs in G, to interact with the target (user's) environment and ignore the action outputs of the irrelevant ones. E.g., in FIG. 9, the output a_{3,4} and a_{4,3} in Mₛ(Gₛ) 910A does not project to any vertex (LNE pair) in G_{*} 910B. Thus, they may be ignored,
   knowledge distillation from Mₛ (Gₛ) 1010A to M_{*}(G_{*}) 1010B: applying a transfer learning approach called knowledge distillation. The knowledge distillation effectively learns a small student model from a large teacher model. In this case, the source data related to Gₛ and the pretrained model Mₛ(Gₛ) 1010A may be used to augment new samples 1002 that fit the state and action dimensions of M_{*}(G_{*}) 1010B, and train (e.g., via loss 1003) M_{*}(G_{*}) 1010B to learn the behavior of Mₛ(Gₛ) 1010A with these samples 1002. An example is shown in diagram 1000 of FIG. 10 (which illustrates an example of knowledge distillation from Mₛ (Gₛ) 1010A to M_{*} (G_{*}) 1010B, with actor network 1001A, 1001B, respectively).

Further features of the SON node device 210 directly result from the functionalities and parameters of the communications network device 200 and thus are not repeated here.

FIG. 2C is a block diagram of the network service provider device 220, in accordance with an example embodiment.

The network service provider device 220 comprises at least one processor 222 and at least one memory 224 including computer program code. The network service provider device 220 may also include other elements, such as a transceiver configured to enable the network service provider device 220 to transmit and/or receive information to/from other devices, as well as other elements not shown in FIG. 2C.

Although the network service provider device 220 is depicted to include only one processor 222, the network service provider device 220 may include more processors. In an embodiment, the memory 224 is capable of storing instructions, such as an operating system and/or various applications. Furthermore, the memory 224 may include a storage that may be used to store, e.g., at least some of the information and data used in the disclosed embodiments.

Furthermore, the processor 222 is capable of executing the stored instructions. In an embodiment, the processor 222 may be embodied as a multi-core processor, a single core processor, or a combination of one or more multi-core processors and one or more single core processors. For example, the processor 222 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 222 may be configured to execute hard-coded functionality. In an embodiment, the processor 222 is embodied as an executor of software instructions, wherein the instructions may specifically configure the processor 222 to perform the algorithms and/or operations described herein when the instructions are executed.

The memory 224 may be embodied as one or more volatile memory devices, one or more non-volatile memory devices, and/or a combination of one or more volatile memory devices and non-volatile memory devices. For example, the memory 224 may be embodied as semiconductor memories (such as mask ROM, PROM (programmable ROM), EPROM (erasable PROM), flash ROM, RAM (random access memory), etc.).

The at least one memory 224 and the computer program code are configured to, with the at least one processor 222, cause the network service provider device 220 at least to obtain from at least one communications network device 200 at least one subgraph of a logical network graph representing mobility relations between LNE pairs and their associated profiles.

The at least one memory 224 and the computer program code are further configured to, with the at least one processor 222, cause the network service provider device 220 at least to derive at least one pretrained reference DRL model for use in solving an optimization problem related to a SON function within a SCOR. As discussed in more detail above, the SCOR comprises at least one LNE pair and the SCOR corresponds to the subgraph.

The at least one memory 224 and the computer program code are further configured to, with the at least one processor 222, cause the network service provider device 220 at least to store the obtained profiles and the derived pretrained reference DRL models in the model database 230A, 230B, 230C.

In other words, the network service provider device 220 may obtain the sub-MRGs and their profiles with its MRG generation function. Then, the network service provider device 220 may apply its SCOR-based SON functions online in its network environment and/or offline on its collected dataset and derive the pretrained reference DRL models. The profiles and the models may be stored in the SON model DB 230 as reference models to be retrieved by users or other service providers.

At least in some embodiments, the model database 230A, 230B, 230C may comprise an indexed model database such that a same index represents an obtained profile of one subgraph and a corresponding derived pretrained reference DRL model in a SCOR that corresponds to the subgraph.

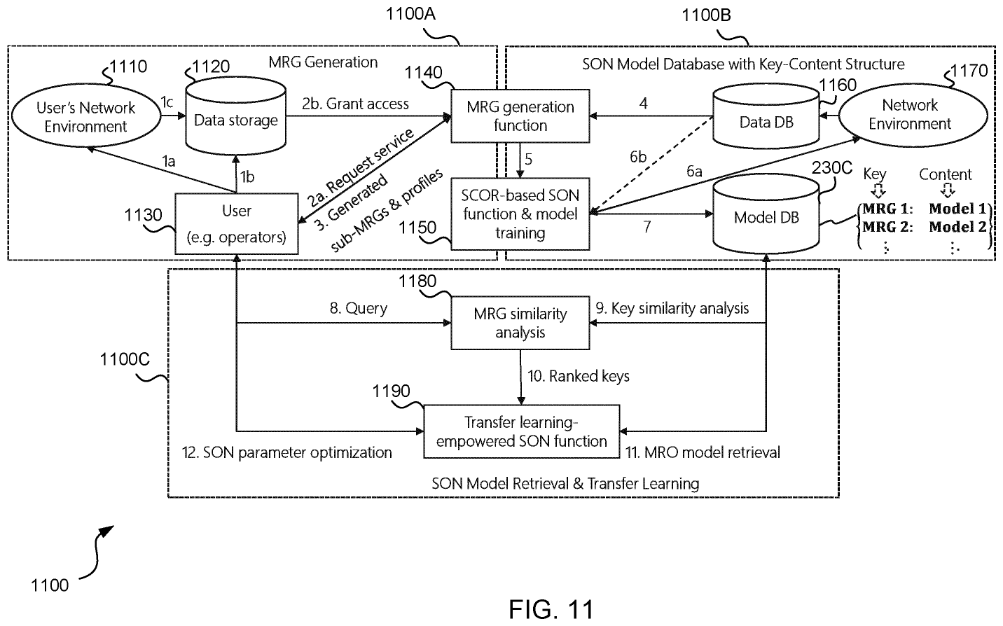

In other words, e.g., for more efficient query an index-profile DB 230A and/or an index-model DB 230B may be built, such that the sub-MRG's corresponding profile and its pre-trained model may be accessed independently with the same index. For the sub-MRG similarity analysis, the index-profile DB 230A may be accessed to find the sub-MRG profile with the highest similarity. Then, the index of the found sub-MRG may be used to retrieve the model in the index-model DB 230B. In this case, the SON model DB 230C in FIG. 11 may be replaced by the index-profile DB 230A and an index-model DB 230B shown in diagram 700 of FIG. 7 (which illustrates an example of an indexed profile database 230A and an indexed model database 230B where sub-MRG 1 309A is associated to the profile 1 701 and the pre-trained model 1 703, while sub-MRG 2 309B is associated to the profile 2 702 and the pre-trained model 2 704).

Further features of the network service provider device 220 directly result from the functionalities and parameters of the communications network device 200 and the SON node device 210, and thus are not repeated here.

Diagram 1100 of FIG. 11 illustrates an overview of the disclosed embodiments. More specifically, diagram 1100 of FIG. 11 illustrates a transfer learning framework with logical network graph-based model retrieval, MRG generation, decomposition of the MRG to subgraphs and their corresponding SCORs, subgraph profiling, and DRL model retrieval based on a subgraph similarity analysis. The transfer learning framework of diagram 1100 of FIG. 11 may be implemented with any combination of the communications network device 200, the SON node device 210 and the network service provider device 220.

The main functional blocks in FIG. 11 include:
MRG generation, partitioning, and profiling 1100A: for partitioning a large-scale network graph to sub-MRGs with minimum dependencies. A sub-MRG may represent a SCOR, i.e., a strongly coupled SLA coverage overlap and mobility dependent region;
building a SCOR-based reference model DB with key-content data structure 1100B:
   keys: profiles of the sub-MRGs, and
   contents: pre-trained SCOR-based distributed DRL models.
MRG similarity analysis, model retrieval, and transfer learning 1100C: the profile of the sub-MRG may be used for similarity analysis and model retrieval. The retrieved model may be reproduced and fine-tuned to a customized model with, e.g., transfer learning.

The workflow in FIG. 11 may include, e.g., at least some of the following:
steps 1a, 1b, 1c: a user (e.g., an operator) 1130 saves network measurements in its network environment 1110 in a data storage 1120. The data storage 1120 may be, e.g., in operations and maintenance (O&M) or other cloud data servers,
steps 2a, 2b: the user 1130 requests MRG generation service and grants the service function 1140 access to process its data,
step 3: upon the request of the user 1130, the MRG generation service 1140 generates a networkwide MRG and partitions it to sub-MRGs. It also profiles the sub-MRGs and sends back the profiles,
step 4: the service provider (e.g., the network service provider device 220) applies the MRG generation service function 1140 to its collected data 1160, obtains a set of reference sub-MRGs and an offline dataset in the corresponding SCOR for training a local DRL agent,
step 5: the SON function module 1150 (e.g., the SON node device 210) obtains the reference SCORs and the corresponding sub-MRGs,
steps 6a, 6b: the service provider (e.g., the network service provider device 220) applies SCOR-based SON functions (e.g., a distributed multi-agent MRO algorithm) online in its network environment 1170 and/or offline on its collected dataset 1160, and derives the pre-trained reference DRL models,
step 7: the service provider (e.g., the service provider 220) saves the pretrained SCOR-based DRL models and their corresponding sub-MRG profiles in the SON model DB 230C,
step 8: the user 1130 makes a query and sends its sub-MRG profiles to a MRG similarity analysis service 1180,
step 9: the MRG similarity analysis function 1180 finds matching keys,
step 10: the MRG similarity analysis function 1180 reports the matching key to a transfer learning-empowered SON function 1190,
step 11: based on the matching key, the transfer learning-empowered SON function 1190 retrieves the pretrained model upon the request of the user 1130, and/or
step 12: the transfer learning-empowered SON function 1190 applies transfer learning techniques to fine-tune the retrieved DRL models on the environment 1110 of the user 1130 and/or the dataset 1120 of the user 1130 and customizes the models for the user 1130.

The disclosed transfer learning framework for distributed multi-agent SON functions may be added into an O-RAN AI/ML workflow.

In the following, alternatives for the MRG generation are briefly discussed.

Alternative 1—generating the MRG and its decomposition to SCORs from HO statistics: in case the LNE logs data is not available, the HO statistics and adjacent relationship may be exploited to generate the MRG, e.g., using neighboring cell list and HO metrics, such as the number of HO success between neighboring nodes. Also, a mobility graph may be created from the statistical data of previous handovers. However, unlike in the MRG generation described above, here, a vertex defines an LNE and an edge defines an LNE pair. Thus, when decomposing the graph, the boundaries between the subgraphs are not included in any of the subgraphs. Because the aim is to optimize per LNE pair HO parameters, the edges need to be grouped, but not the vertices. To this end, a heuristic step may be applied to add the edge (LNE pair) between two subgraphs to the subgraph with less members.

Alternative 2—generating the MRG and its decomposition to SCORs from an SLA coverage map: in case neither the LNE logs data nor the mobility statistics are available, e.g., for a network in planning or a newly deployed network system, sufficient historical user logs or mobility statistics are not available. Then, either a simulated (e.g., from a simulator or a digital twin) or measured SLA coverage map (e.g., from a driving test) may be used to generate the MRG.

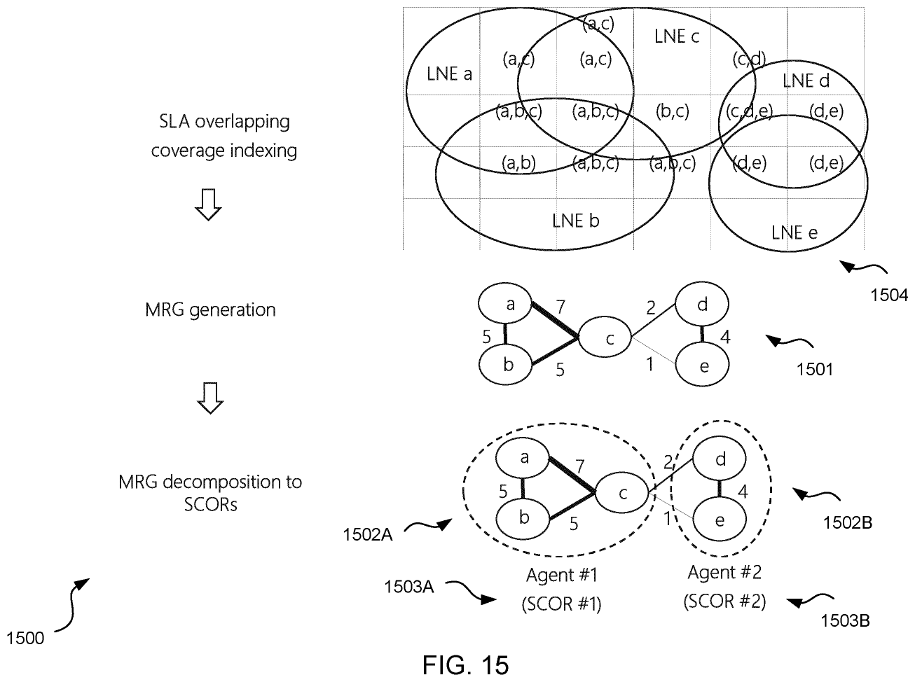

An MRG G=(V, E) may be derived from the SLA coverage map, as shown in FIG. 15. Diagram 1500 of FIG. 15 illustrates deriving an MRG 1501 and SCORs 1503A, 1503B from an SLA coverage map 1504.

Here, the vertices are the LNEs instead of LNE pairs. Since the CIOs and TTTs are defined per LNE pairs, the SCOR is further defined based on the edges of the MRG (an edge indicates the mobility interaction between two LNEs). The steps may include, e.g., at least some of the following:
1. the mobility playground may be gridded spatially. Each grid is marked by a set of LNE indices: if the SLA coverage of an LNE (partially) covers a grid, the index of the LNE is included. It is to be noted that for different geographical areas the size of the grid may be different. E.g., a rural area may have a larger size and urban area may have a smaller size. The sizes of the grids may be dynamically configured depending on the UE or service density,
2. each vertex of the MRG 1501 defines an LNE. The weight of an edge between two LNEs may be computed by counting the number of the coverage overlapped grids of two LNEs if at least one LNE is in the neighboring LNE list of another,
3. classical graph decomposition/partition schemes may be used to decompose the MRG 1501 to subgraphs 1502A, 1502B,
4. because the CIOs and TTTs are defined per LNE pair, groups of LNE pairs may need to be obtained from the decomposed MRG. The vertices of the MRG in this scheme are the LNEs, while the edges are the LNE pairs. Same heuristics may be used to add the edges between the subgraphs to the one with less members to balance the agent scale. One SCOR 1503A (optimized by a first agent) may comprise, e.g., LNE pairs {(a, b), (b, c), (a, c)}, while another SCOR 1593B (optimized by a second agent) may comprise LNE pairs {(d, e), (c, d), (c, e)}.

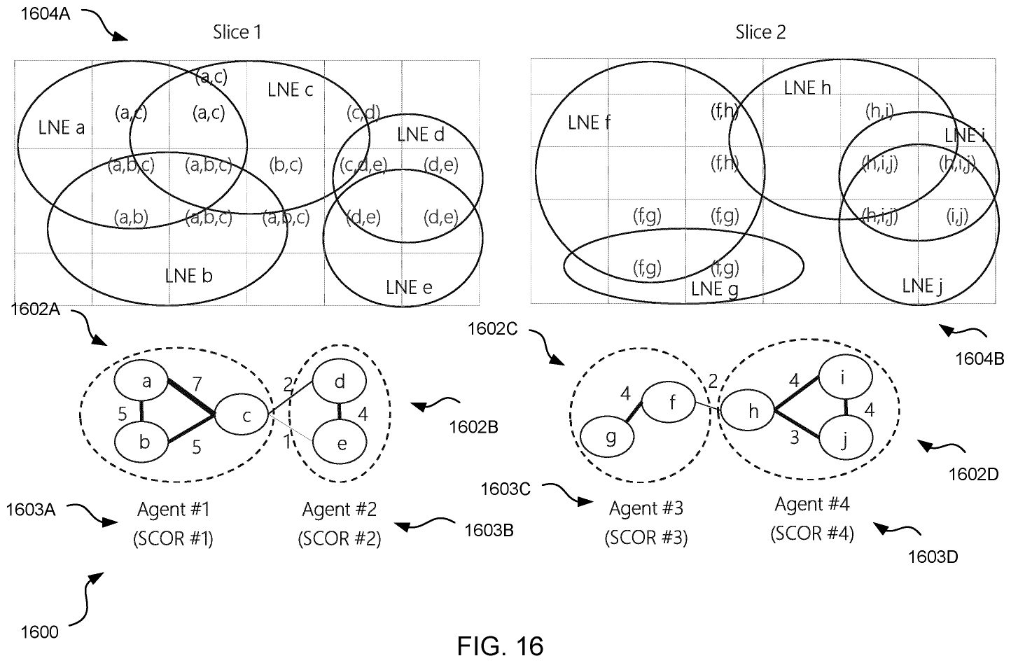

Diagram 1600 of FIG. 16 illustrates MRG decomposition when an LNE is defined as a network slice in a physical cell. The MRG 1602A, 1602B, 1602C, 1602D are decomposed to four agents optimizing four SCORS, SCOR_1={(a, b), (b, c), (a, c)} 1603A, SCOR_2={(d, e), (c, d), (c, e)} 1603B, SCOR_3={(g, f), (f, h)} 1603C, SCOR_4={(h, i), (I, j), (h, j)} 1603D, respectively. In the case where an LNE is a logical slice in a physical cell, there are SLA coverage maps 1604A, 1604B of each slice. FIG. 16 is an example of how the decomposed SCORs 1603A, 1603B, 1603C, 1603D may be derived from the two SLA coverage maps 1604A, 1604B corresponding to two slices. Without inter-slice HO, the LNEs in Slice 2 are not included in the neighboring LNE lists of the LNEs in Slice 1. Thus, there are no edges between the subgraphs generated by different slice coverage maps, and four decomposed SCORs 1603A, 1603B, 1603C, 1603D may be obtained, each optimized by a distributed agent. Furthermore, the disclosure may be extended to a scenario with inter-slice HO. In that case, edges with higher weights may exist between LNEs connected to different slices, and a SCOR may comprise LNE pairs associated with different slices.

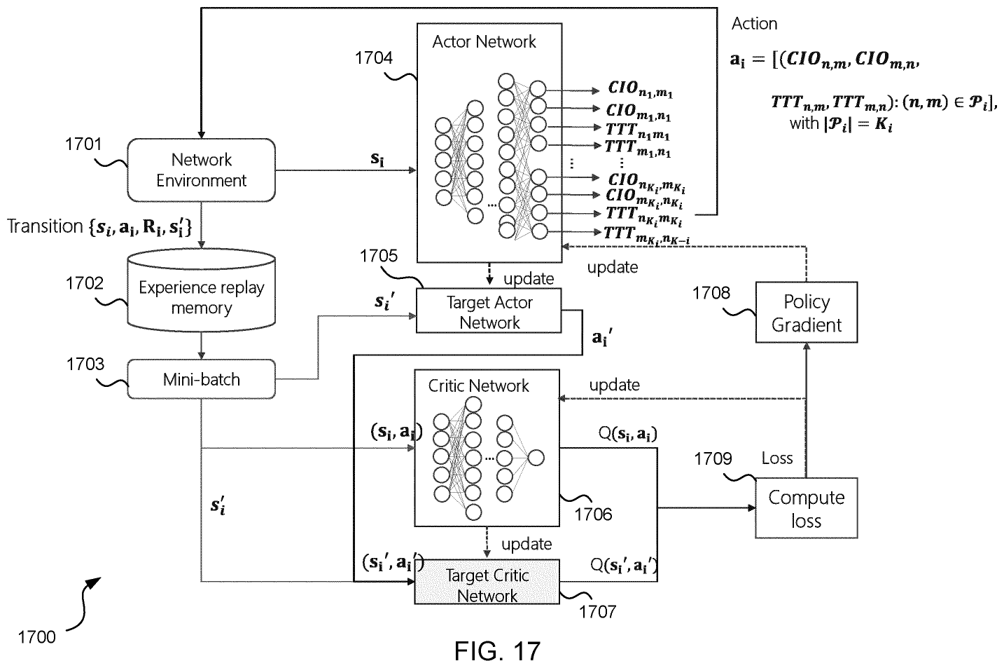

Diagram 1700 of FIG. 17 shows an example embodiment of the subject matter described herein illustrating an example of a deep deterministic policy gradient (DDPG) architecture of a local agent i with actions of CIO and TTT values in a continuous space. The example DDPG architecture comprises a network environment 1701, an experience replay memory 1702, a minibatch 1703, an actor network 1704, a target actor network 1705, a critic network 1706, a target critic network 1707, a policy gradient 1708, and a loss computing block 1709.

In other words, diagram 1700 of FIG. 17 is an example of the above-discussed model I with continuous CIO and TTT values (defined in a continuous action space) of the DRL model for an agent with an actor-critic architecture. The elements of state, action and reward may include those discussed above. The actor network 1704 may include a policy network that takes the state as input and outputs the exact continuous action instead of a probability distribution over actions. The critic network 1706 may include a Q-value network that takes in state and action as input and outputs the Q-value. Experience replay memory 1702 may include a replay memory technique used in reinforcement learning where the agent's experiences are stored at each timestep. The target critic network 1707 may include a copy of an action-value function (or Q-function) that is held constant to serve as a stable target for learning for a fixed number of timesteps. The policy gradient 1708 may include a computation of a gradient descent to optimize the parameters of the neural network based on an expected return of a long-term cumulative reward. The loss computing block 1709 may compute a loss function of the networks based on but not limited to the computed reward.

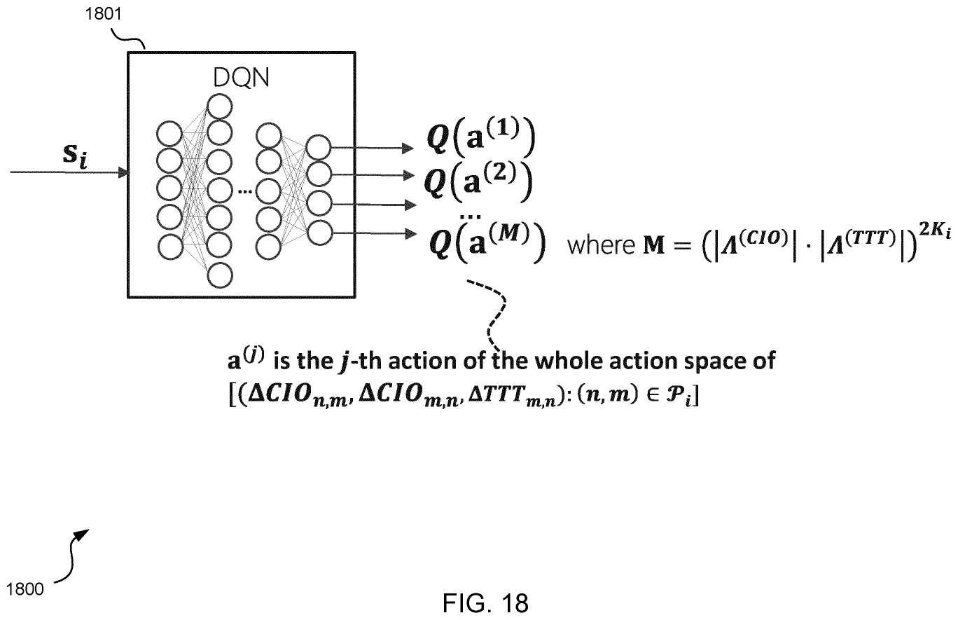

Diagram 1800 of FIG. 18 shows an example embodiment of the subject matter described herein illustrating an example of a deep Q-network (DON) architecture 1801 of a local agent i with actions of step sizes of CIO and TTT adjustments in a discrete space. As discussed above in more detail, inputs si may include, e.g., LNE-specific metrics (e.g., a number of UEs, load, a distribution of COIs, QoS-related metrics, other configurations) and/or LNE-pair specific metrics (e.g., HO-related metrics, other context information).

In other words, diagram 1800 of FIG. 18 is an example of the above-discussed model II with a discrete step size of CIO and TTT adjustment (having a discrete action space) of the DRL model for an agent with a DON architecture. The elements of state, action and reward may include those discussed above.

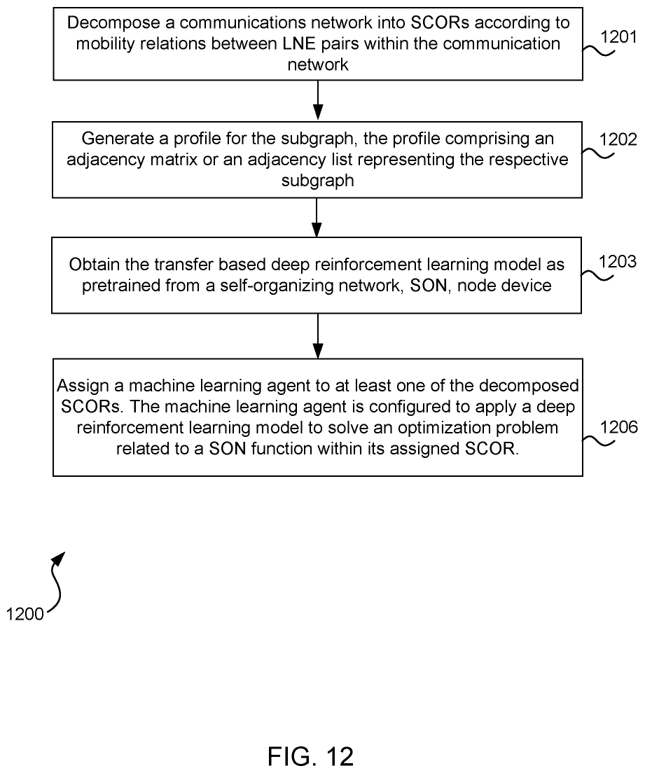

FIG. 12 illustrates an example flow chart of a method 1200, in accordance with an example embodiment.

At operation 1201, the communications network device 200 decomposes the communications network 110 into the SCORs according to mobility relations between LNE pairs within the communication network 110. As discussed in more detail above, the SCOR comprises at least one LNE pair.

At optional operation 1202, the communications network device 200 may generate a profile for the subgraph(s), the profile(s) comprising an adjacency matrix or an adjacency list representing the respective subgraph.

At optional operation 1203, the communications network device 200 may obtain a DRL model as pretrained from the SON node device 210.

At operation 1204, the communications network device 200 assigns a machine learning agent (e.g., the pretrained one obtained in operation 1203) to at least one of the decomposed SCORs. The machine learning agent is configured to apply a DRL model to solve an optimization problem related to a SON function within its assigned SCOR.

The method 1200 may be performed by the communications network device 200 of FIG. 2A. The operations 1201-1204 can, for example, be performed by the at least one processor 202 and the at least one memory 204. Further features of the method 1200 directly result from the functionalities and parameters of the communications network device 200, and thus are not repeated here. The method 1200 can be performed by computer program(s).

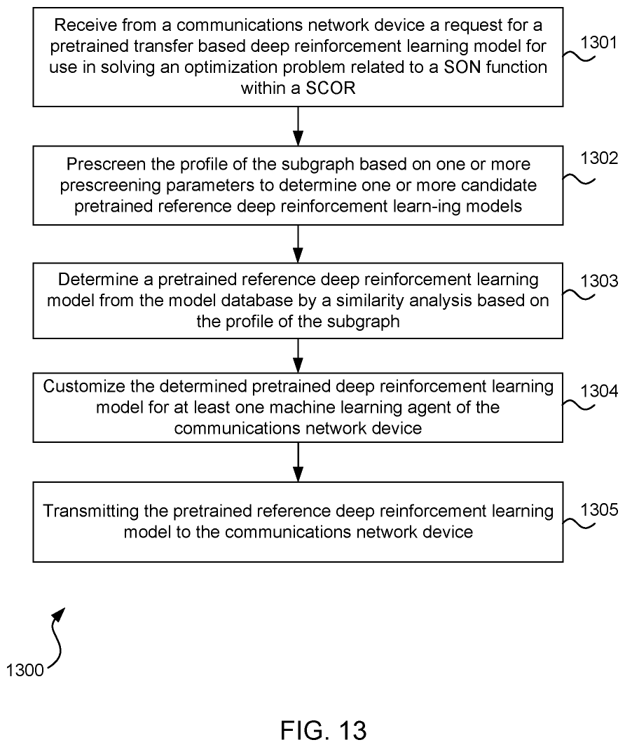

FIG. 13 illustrates an example flow chart of a method 1300, in accordance with an example embodiment.

At operation 1301, the SON node device 210 receives from the communications network device 200 a request for a pretrained DRL model for use in solving an optimization problem related to a SON function within a SCOR. The request comprises at least one profile of at least one subgraph of a logical network graph representing mobility relations between LNE pairs, with the SCOR comprising at least one LNE pair, and the at least one subgraph corresponding to the SCOR.

At optional operation 1302, the SON node device 210 may prescreen the profile of the subgraph based on one or more prescreening parameters to determine one or more candidate pretrained reference DRL models.

At operation 1303, the SON node device 210 determines a pretrained reference DRL model from the model database 230A, 230B, 230C by a similarity analysis based on the profile of the subgraph. When the prescreening of operation 1302 in performed, the determining of the pretrained reference DRL model may be performed on the determined one or more candidate pretrained reference DRL models.

At optional operation 1304, the SON node device 210 may customize the determined pretrained reference DRL model, e.g., for at least one machine learning agent of the communications network device 200. For example, the customized DRL model may comprise a TL-DRL model.

At operation 1305, the SON node device 210 transmits the (determined/customized) pretrained reference DRL model (e.g., a TL-DRL model) to the communications network device 200.

The method 1300 may be performed by the SON node device 210 of FIG. 2B. The operations 1301-1305 can, for example, be performed by the at least one processor 212 and the at least one memory 214. Further features of the method 1300 directly result from the functionalities and parameters of the SON node device 210, and thus are not repeated here. The method 1300 can be performed by computer program(s).

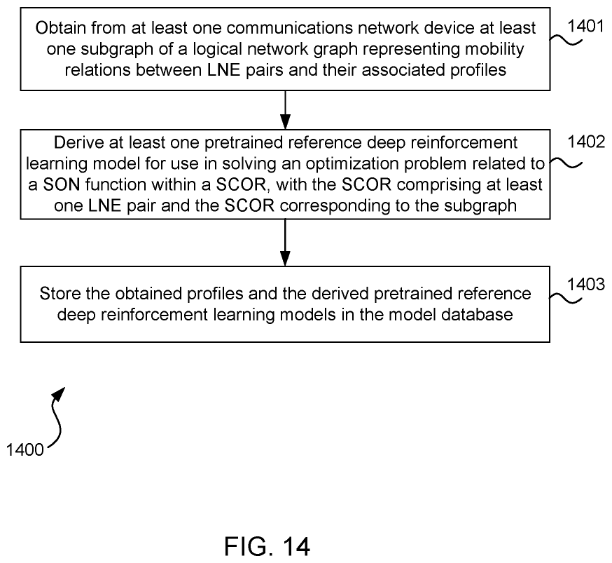

FIG. 14 illustrates an example flow chart of a method 1400, in accordance with an example embodiment.

At operation 1401, the network service provider device 220 obtains from at least one communications network device 200 at least one subgraph of a logical network graph representing mobility relations between LNE pairs and their associated profiles.

At operation 1402, the network service provider device 220 derives at least one pretrained reference DRL model for use in solving an optimization problem related to a SON function within a SCOR, with the SCOR comprising at least one LNE pair, and the SCOR corresponding to the subgraph.

At operation 1403, the network service provider device 220 stores the obtained profiles and the derived pretrained reference DRL models (e.g., TL-DRL models) in the model database 230A, 230B, 230C.

The method 1400 may be performed by the network service provider device 220 of FIG. 2C. The operations 1401-1403 can, for example, be performed by the at least one processor 222 and the at least one memory 224. Further features of the method 1400 directly result from the functionalities and parameters of the network service provider device 220, and thus are not repeated here. The method 1400 can be performed by computer program(s).

At least some of the embodiments may allow a distributed multi-agent DRL algorithm for an MRO problem, where each agent may comprise a varying number of physical or logical network boundaries. At least some of the embodiments may allow minimizing the inter-agent dependencies by decomposing the network mobility graph. Such decomposition may provide proper granularity to deploy distributed learning agents, which may achieve a good tradeoff between low model complexity and good model accuracy.

At least some of the embodiments may allow a transfer learning framework for SON model profiling, storage, retrieval, retraining, and management such that one can efficiently retrieve the SON model that was pretrained in a similar (sub) network environment. At least some of the embodiments may allow analyzing the similarity between the relational network graph data. This approach may be especially beneficial for SON use cases because it captures the strong interaction between the network entities within a local agent.

At least some of the embodiments may allow SON service providers and their customers to easily produce, archive, share, and reproduce SON models in an open, multi-vendor, and multi-stakeholder platform.

At least some of the embodiments may allow eithe online training (e.g., using the live network and its data to train) or offline training to generate the transfer model or a combination of online and offline training. The convergence times may be offset by more real time data.

At least some of the embodiments may allow SON and O-RAN/virtualized RAN (VRAN) network optimization.

The communications network device 200 may comprise means for performing at least one method described herein. In an example, the means may comprise the at least one processor 202, and the at least one memory 204 including program code configured to, when executed by the at least one processor 202, cause the communications network device 200 to perform the method.

The SON node device 210 may comprise means for performing at least one method described herein. In an example, the means may comprise the at least one processor 212, and the at least one memory 214 including program code configured to, when executed by the at least one processor 212, cause the SON node device 210 to perform the method. The SON node device 210 may comprise a group of virtualized network optimization functions which may be implemented as cloud computing service(s).

The network service provider device 220 may comprise means for performing at least one method described herein. In an example, the means may comprise the at least one processor 222, and the at least one memory 224 including program code configured to, when executed by the at least one processor 222, cause the network service provider device 220 to perform the method.

The communications network device 200, the SON node device 210, and/or the network service provider device 220 may be implemented as separate physical devices. Alternatively, any combination of the communications network device 200, the SON node device 210, and the network service provider device 220 may be implemented as a single physical device.

The functionality described herein can be performed, at least in part, by one or more computer program product components such as software components. According to an embodiment, the communications network device 200, the SON node device 210 and/or the network service provider device 220 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific: Standard Products (ASSPs), System-on-a-chip systems (SOCs), Complex Programmable Logic Devices (CPLDs), and Graphics Processing Units (GPUS).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A communications network device, comprising:
at least one processor; and
at least one memory including computer program code;
the at least one memory and the computer program code configured to, with the at least one processor, cause the communications network device at least to:
decompose a communications network into service level agreement, SLA, coverage overlap regions, SCORs, according to mobility relations between logical network entity, LNE, pairs within the communication network, said SCOR comprising at least one LNE pair; and
assign a machine learning agent to at least one of the decomposed SCORs,
wherein said machine learning agent is configured to apply a deep reinforcement learning model to solve an optimization problem related to a self-organizing network, SON, function within its assigned SCOR.

2. The communications network device according to claim 1, wherein LNE pairs in a SCOR comprising at least two LNE pairs are strongly coupled, and dependency between the SCORs is low.

3. The communications network device according to claim 2, wherein the at least one memory and the computer program code are further configured to, with the at least one processor, cause the communications network device to decompose the communications network into the SCORs by:
generating a logical network graph corresponding to the communications network and representing the mobility relations between the LNE pairs; and
decomposing the logical network graph into subgraphs, said subgraphs representing SCORs comprising strongly coupled LNE pairs.

4. The communications network device according to claim 3, wherein vertices of the logical network graph comprise the LNE pairs, and weights of edges of the logical network graph reflect a mobility relationship between two LNE pairs.

5. The communications network device according to claim 1, wherein the at least one memory and the computer program code are further configured to, with the at least one processor, cause the communications network device at least to generate a profile for said subgraph, said profile comprising an adjacency matrix or an adjacency list representing the respective subgraph.

6. The communications network device according to claim 5, wherein said profile further comprises at least one of: a number of vertices, a number of edges, a number of involved LNEs, a degree distribution, a distribution of edge weights, a distribution of summed weights of edges incident to a vertex, or at least one LNE specific feature for the respective subgraph including at least one of a deployment type, an LNE type, an associated user mobility distribution, position information, or an LNE load state.

7. The communications network device according to claim 1, wherein the at least one memory and the computer program code are further configured to, with the at least one processor, cause the communications network device at least to obtain the deep reinforcement learning model as pretrained from a SON node device.

8. The communications network device according to claim 1, wherein states of said assigned machine learning agent comprise at least one of: LNE-specific metrics, LNE pair-specific metrics, or contextual information for capturing at least one of temporal or spatial correlations.

9. The communications network device according to claim 1, wherein an action space of said assigned machine learning agent comprises a discrete action space or a continuous action space.

10. The communications network device according to claim 9, wherein rewards for said assigned machine learning agent are based on at least one of: LNE pair-specific handover performance metrics, LNE-specific quality of service, QoS, performance metrics, or LNE pair-specific QoS performance metrics.

11. The communications network device according to claim 1, wherein the SON function comprises a mobility robustness optimization, MRO, function, a coverage and capacity optimization function, or a mobility load balancing function.

12. The communications network device according to claim 11, wherein the MRO function comprises optimization of one or more handover parameters.

13. The communications network device according to claim 1, wherein said SCOR further comprises a group of physical cell boundaries, a group of logical cell boundaries, or a group of physical cell boundaries and logical cell boundaries.

14. The communications network device according to claim 1, wherein the LNEs comprise at least one of cells, slices, or QoS flows.

15. The communications network device according to claim 3, wherein the generating of the logical network graph comprises generating the logical network graph based on historical LNE data, statistical mobility data, or an SLA coverage map.

16. (canceled)

17. A method, comprising:
decomposing, by a communications network device, a communications network into service level agreement, SLA, coverage overlap regions, SCORs, according to mobility relations between logical network entity, LNE, pairs within the communication network, said SCOR comprising at least one LNE pair; and
assigning, by the communications network device, a machine learning agent to at least one of the decomposed SCORs,
wherein said machine learning agent is configured to apply a deep reinforcement learning model to solve an optimization problem related to a self-organizing network, SON, function within its assigned SCOR.

18. A computer program comprising instructions for causing a communications network device to perform at least the following:
decomposing a communications network into service level agreement, SLA, coverage overlap regions, SCORs, according to mobility relations between logical network entity, LNE, pairs within the communication network, said SCOR comprising at least one LNE pair; and
assigning a machine learning agent to at least one of the decomposed SCORs,
wherein said machine learning agent is configured to apply a deep reinforcement learning model to solve an optimization problem related to a self-organizing network, SON, function within its assigned SCOR.

19-30. (canceled)
